(19) United States
(12) Patent Application Publication
(10) Pub. No.: US 2024/0259709 A1
(43) Pub. Date: Aug. 1, 2024

(54) DISTANCE IMAGE CAPTURING DEVICE, DISTANCE IMAGE CAPTURING METHOD, AND PROGRAM

(71) Applicant: TOPPAN Holdings Inc., Tokyo (JP)

(72) Inventors: Satoshi TAKAHASHI, Tokyo (JP); Satoshi OHKUMA, Tokyo (JP); Yasuyuki HITSUOKA, Tokyo (JP); Yuhi MORITA, Tokyo (JP)

(73) Assignee: TOPPAN Holdings Inc., Tokyo (JP)

(21) Appl. No.: 18/423,447

(22) Filed: Jan. 26, 2024

(30) Foreign Application Priority Data
Jan. 30, 2023 (JP) 2023-011883
Nov. 30, 2023 (JP) 2023-203222

(51) Int. Cl. H04N 25/71; G06T 7/13; G06T 7/20; G06V 10/141; G06V 10/74; H04N 23/65

(52) U.S. Cl. CPC H04N 25/71; G06T 7/13; G06T 7/20; G06V 10/141; G06V 10/761; H04N 23/651

(57) ABSTRACT

A distance image processing unit executes either the normal mode or a power saving mode having lower power consumption than the normal mode, in the power saving mode, accumulates the charge in the charge accumulation unit at a frequency which is the same as that in the normal mode or smaller than that in the normal mode, determines whether or not a moving object is present in the space, and releases the power saving mode as satisfying a return condition in a case where the moving object is present in the space, and determines whether a moving object is present in the space according to the amount of charge accumulated in each of the charge accumulation units in the normal mode, and shifts to the power saving mode in a case where determining that the moving object is not present in the space.

### CROSS REFERENCE TO RELATED APPLICATIONS

This application is a continuation application based on Japanese Patent Application No. 2023-011883, filed on Jan. 30, 2023, and Japanese Patent Application No. 2023-203222, filed on Nov. 30, 2023, both contents of which are incorporated herein by reference.

### BACKGROUND OF THE INVENTION

### Field of the Invention

The present invention relates to a distance image capturing device, a distance image capturing method, and a program.

### Description of Related Art

In the related art, a time of flight (hereinafter, referred to as “TOF”) type distance image capturing device has been implemented that uses a known speed of light and measures a distance between a measuring instrument and an object based on a flight time of light in space (measurement space) (for example, refer to Japanese Patent No. 4235729).

Such a distance image capturing device can be applied to, for example, human flow detection for measuring the movement of an object in a capturing target space.

### SUMMARY OF THE INVENTION

In a case where a moving object is to be detected in human flow detection or the like, the moving object is not normally present in the capturing target space. Since the distance image capturing device is a so-called active sensor that emits an optical pulse, power consumption increases when the measurement is continued. As a countermeasure, it is desirable to suppress the power consumption of the distance image capturing device by providing a sleep function such that measurement is not performed in a case where the moving object is not present in the capturing target space. For example, it is conceivable to apply a sleep function in a general-purpose information processing device such as a personal computer to the distance image capturing device.

However, although the distance image capturing device can detect that the moving object is not present in the capturing target space during the measurement and stop the measurement, the distance image capturing device cannot detect that the moving object enters the capturing target space in a case where the measurement is not performed. That is, once in a sleep state, it is difficult for the distance image capturing device to return to an original capturing state, and the sleep function in a general-purpose information processing device such as a personal computer cannot be applied as it is. Therefore, it is desired to implement a sleep function suitable for the distance image capturing device.

The present invention has been made in view of such circumstances, and provides a distance image capturing device, a distance image capturing method, and a program capable of executing processing related to a sleep function suitable for a distance image capturing device.

A distance image capturing device according to the present disclosure includes a light source unit configured to emit an optical pulse to a space which is a capturing target, a light receiving unit configured to include a pixel having a photoelectric conversion element which generates a charge according to a light incident from the space and a plurality of charge accumulation units that accumulate the charge, and a pixel driving circuit which performs driving for accumulating the charge in each of the charge accumulation units to accumulate the charge, and a distance image processing unit configured to control the pixel driving circuit, accumulate the charge in each of the charge accumulation units at an accumulation timing synchronized with an emission timing of emitting the optical pulse in a normal mode, and calculate a distance to a subject present in the space based on an amount of charge accumulated in each of the charge accumulation units, in which the distance image processing unit executes either the normal mode or a power saving mode having lower power consumption than the normal mode, in the power saving mode, accumulates the charge in the charge accumulation unit at a frequency which is the same as that in the normal mode or smaller than that in the normal mode, determines whether or not a moving object is present in the space according to the amount of charge accumulated in the charge accumulation unit, and releases the power saving mode as satisfying a return condition in a case where the moving object is present in the space, and determines whether a moving object is present in the space according to the amount of charge accumulated in each of the charge accumulation units in the normal mode, and shifts to the power saving mode in a case where the distance image processing unit is determined that the moving object is not present in the space.

A distance image capturing method of the present disclosure performed by a distance image capturing device including a light source unit configured to emit an optical pulse to a space which is a capturing target, a light receiving unit configured to include a pixel having a photoelectric conversion element which generates a charge according to a light incident from the space and a plurality of charge accumulation units that accumulate the charge, and a pixel driving circuit which performs driving for accumulating the charge in each of the charge accumulation units, and a distance image processing unit configured to control the pixel driving circuit, accumulates the charge in each of the charge accumulation units at an accumulation timing synchronized with an emission timing of emitting the optical pulse in a normal mode, and calculates a distance to a subject present in the space based on an amount of charge accumulated in each of the charge accumulation units, the method including, via the distance image processing unit, executing either the normal mode or a power saving mode having lower power consumption than the normal mode, in the power saving mode, accumulating the charge in the charge accumulation unit at a frequency which is the same as that in the normal mode or smaller than that in the normal mode, determining whether or not a moving object is present in the space according to the amount of charge accumulated in the charge accumulation unit, and releasing the power saving mode as satisfying a return condition in a case where the moving object is present in the space, and determining whether a moving object is present in the space according to the amount of charge accumulated in each of the charge accumulation units in the normal mode, and shifting to the power saving mode in a case where the distance image processing unit is determined that the moving object is not present in the space.

A storage medium according to the present disclosure is a non-transitory computer-readable storage medium storing a program for causing a computer of a distance image capturing device including a light source unit configured to emit an optical pulse to a space which is a capturing target, a light receiving unit configured to include a pixel having a photoelectric conversion element which generates a charge according to a light incident from the space and a plurality of charge accumulation units that accumulate the charge, and a pixel driving circuit which performs driving for accumulating the charge in each of the charge accumulation units, and a distance image processing unit configured to control the pixel driving circuit, accumulates the charge in each of the charge accumulation units at an accumulation timing synchronized with an emission timing of emitting the optical pulse in a normal mode, and calculates a distance to a subject present in the space based on an amount of charge accumulated in each of the charge accumulation units, to execute a process including executing either the normal mode or a power saving mode having lower power consumption than the normal mode, in the power saving mode, accumulating the charge in the charge accumulation unit at a frequency which is the same as that in the normal mode or smaller than that in the normal mode, determining whether or not a moving object is present in the space according to the amount of charge accumulated in the charge accumulation unit, and releasing the power saving mode as satisfying a return condition in a case where the moving object is present in the space, and determining whether a moving object is present in the space according to the amount of charge accumulated in each of the charge accumulation units in the normal mode, and shifting to the power saving mode in a case where the distance image processing unit is determined that the moving object is not present in the space.

As described above, according to the present invention, it is possible to execute processing related to the sleep function suitable for the distance image capturing device.

### BRIEF DESCRIPTION OF THE DRAWINGS

FIG. 1 is a block diagram showing a configuration example of a distance image capturing device 1 according to an embodiment.

FIG. 2 is a block diagram showing a configuration example of a distance image sensor 32 according to the embodiment.

FIG. 3 is a circuit diagram showing a configuration example of a pixel 321 according to the embodiment.

FIG. 4 is a flowchart showing a flow of processing performed by a distance image processing unit 4 according to the embodiment.

FIG. 5 is a table showing a power saving mode according to the embodiment.

FIG. 6 is a diagram showing a normal mode according to the embodiment.

FIG. 7 is a diagram showing a power saving mode M1 according to the embodiment.

FIG. 8 is a diagram showing a power saving mode M2 according to the embodiment.

FIG. 9 is a diagram showing Modification Example 1 of the power saving mode M2 according to the embodiment.

FIG. 10A is a diagram showing Example 1 of a measurement environment according to the embodiment.

FIG. 10B is a diagram showing Example 1 of the measurement environment according to the embodiment.

FIG. 11A is a diagram showing Example 1 of the measurement environment according to the embodiment.

FIG. 11B is a diagram showing Example 1 of the measurement environment according to the embodiment.

FIG. 12 is a diagram showing Example 2 of the measurement environment according to the embodiment.

FIG. 13A is a diagram showing Modification Example 2 of the power saving mode M2 according to the embodiment.

FIG. 13B is a diagram showing Modification Example 2 of the power saving mode M2 according to the embodiment.

FIG. 13C is a diagram showing Modification Example 2 of the power saving mode M2 according to the embodiment.

FIG. 13D is a diagram showing Modification Example 2 of the power saving mode M2 according to the embodiment.

FIG. 13E is a diagram showing Modification Example 2 of the power saving mode M2 according to the embodiment.

FIG. 14A is a table showing a return condition according to the embodiment.

FIG. 14B is a table showing the return condition according to the embodiment.

FIG. 15 is a flowchart showing a flow of processing performed by a distance image processing unit 4 according to a modification example of the embodiment.

FIG. 16 is a flowchart showing an example of a flow of processing of determining the presence or absence of a moving object, which is performed by the distance image processing unit 4 according to the embodiment.

FIG. 17 is a flowchart showing another example of a flow of the processing of determining the presence or absence of the moving object, which is performed by the distance image processing unit 4 according to the embodiment.

FIG. 18 is a diagram showing the processing performed in the flowchart of FIG. 17.

FIG. 19 is a diagram showing the processing performed in the flowchart of FIG. 17.

FIG. 20 is a diagram showing the processing performed in the flowchart of FIG. 17.

FIG. 21 is a diagram showing the processing performed in the flowchart of FIG. 17.

### DETAILED DESCRIPTION OF THE INVENTION

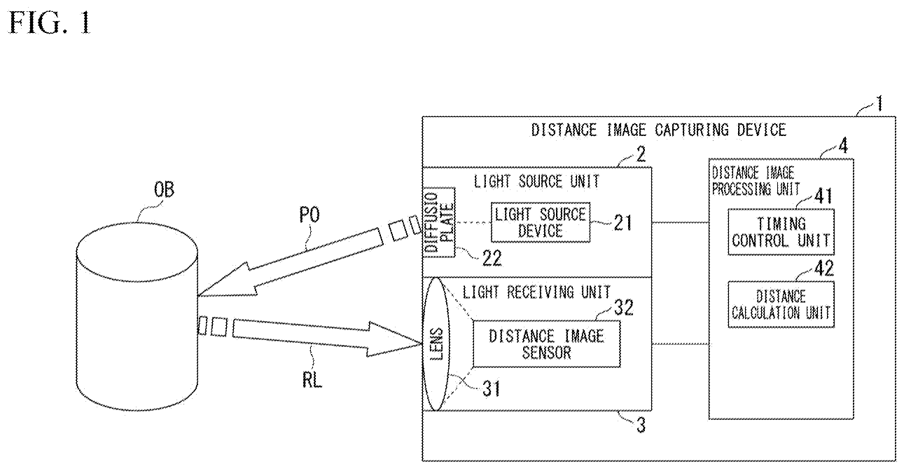

Hereinafter, an embodiment of the present disclosure will be described with reference to the drawings. FIG. 1 is a block diagram showing a configuration example of a distance image capturing device 1. The distance image capturing device 1 includes, for example, a light source unit 2, a light receiving unit 3, and a distance image processing unit 4. FIG. 1 also shows a subject OB, which is an object for measuring a distance in the distance image capturing device 1. A distance image capturing element is, for example, a distance image sensor 32 (described later) in the light receiving unit 3.

According to the control from the distance image processing unit 4, the light source unit 2 emits the optical pulse PO to a space where the subject OB of which the distance is to be measured in the distance image capturing device 1 is present. The light source unit 2 is, for example, a surface emitting semiconductor laser module such as a vertical cavity surface emitting laser (VCSEL). The light source unit 2 includes a light source device 21 and a diffusion plate 22.

The light source device 21 is a light source that emits laser light in a near-infrared wavelength band (for example, a wavelength band with a wavelength of 850 nm to 940 nm) as the optical pulse PO which is emitted to the subject OB. The light source device 21 is, for example, a semiconductor laser light emitting element. The light source device 21 emits pulsed laser light in accordance with the control of a timing control unit 41. The diffusion plate 22 is an optical component that diffuses the laser light in the near-infrared wavelength band emitted by the light source device 21 to a size of a surface for emitting to the subject OB. The pulsed laser light diffused by the diffusion plate 22 is emitted as the optical pulse PO, and emitted to the subject OB.

The light receiving unit 3 receives reflected light RL of the optical pulse PO reflected by the subject OB of which the distance is to be measured in the distance image capturing device 1, and outputs a pixel signal in response to the received reflected light RL. The light receiving unit 3 includes a lens 31 and a distance image sensor 32. The lens 31 is an optical lens that guides the incident reflected light RL to the distance image sensor 32. The lens 31 emits the incident reflected light RL to the distance image sensor 32 side, and the reflected light RL is received (incident) on a pixel circuit provided in a light receiving region of the distance image sensor 32.

The distance image sensor 32 is an image capturing element used in the distance image capturing device 1. The distance image sensor 32 includes a plurality of pixels in a two-dimensional light receiving region. In each of the pixel circuits (pixels 321) of the distance image sensor 32, one photoelectric conversion element, a plurality of charge accumulation units corresponding to the one photoelectric conversion element, and a component that distributes charges to each of the charge accumulation units are provided.

The distance image sensor 32 distributes the charges generated by the photoelectric conversion element to each of the charge accumulation units in accordance with control from the timing control unit 41. In addition, the distance image sensor 32 outputs pixel signals in response to the amount of charge distributed to the charge accumulation units. In the distance image sensor 32, a plurality of pixel circuits are arranged in a two-dimensional matrix, and pixel signals for one frame corresponding to each of the pixel circuits are output.

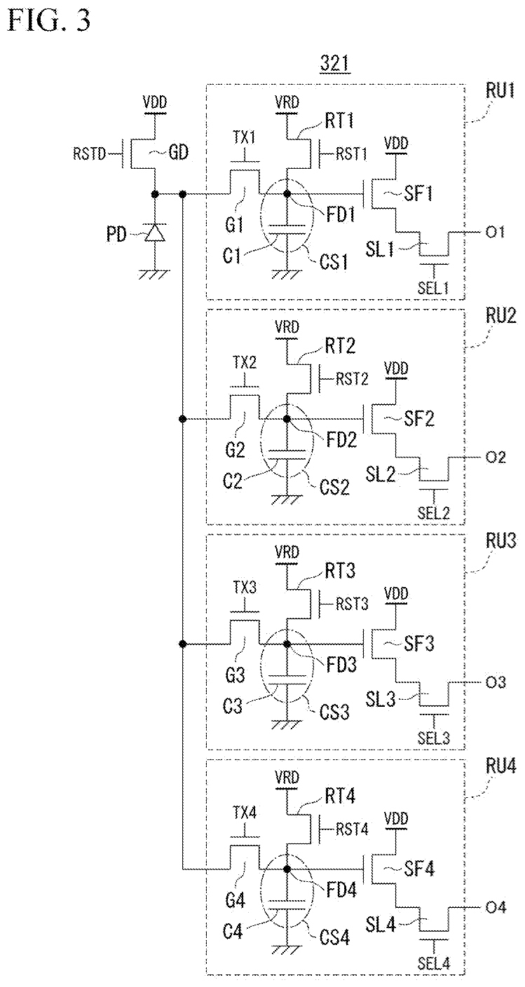

The distance image processing unit 4 controls the distance image capturing device 1 and calculates a distance to the subject OB. The distance image processing unit 4 includes the timing control unit 41 and a distance calculation unit 42. The timing control unit 41 controls the timing of outputting various control signals required for distance measurement. The various control signals here include, for example, a signal that controls the emission of the optical pulse PO, a signal that distributes the reflected light RL to the plurality of charge accumulation units, a signal that discharges charges so that light such as background light (external light) received by the light receiving unit 3 is not accumulated in the charge accumulation unit, and a signal that controls the number of times of distribution per frame. The number of times of distribution is the number of times the processing of distributing the charges in the charge accumulation unit CS (refer to FIG. 3) is repeated.

The distance calculation unit 42 outputs distance information obtained by calculating the distance to the subject OB based on the pixel signal output from the distance image sensor 32. The distance calculation unit 42 calculates a delay time Td from when the optical pulse PO is emitted to when the reflected light RL is received, based on the amount of charge accumulated in a plurality of charge accumulation units CS. The distance calculation unit 42 calculates a distance from the distance image capturing device 1 to the subject OB according to the calculated delay time Td.

With such a configuration, in the distance image capturing device 1, the light receiving unit 3 receives the reflected light RL in which the optical pulse PO in the near-infrared wavelength band emitted to the subject OB by the light source unit 2 is reflected by the subject OB, and the distance image processing unit 4 outputs distance information obtained by measuring the distance between the subject OB and the distance image capturing device 1. Although FIG. 1 shows the distance image capturing device 1 having a configuration in which the distance image processing unit 4 is provided inside, the distance image processing unit 4 may be a component provided outside the distance image capturing device 1.

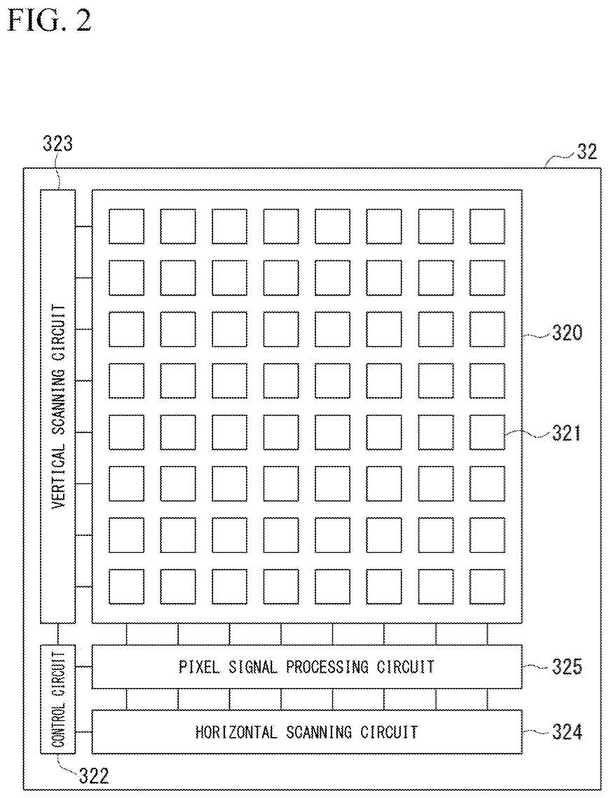

Next, the configuration of the distance image sensor 32 used as the image capturing element in the distance image capturing device 1 will be described. FIG. 2 is a block diagram showing a configuration example of an image capturing element (distance image sensor 32). As shown in FIG. 2, the distance image sensor 32 includes, for example, a light receiving region 320 in which a plurality of pixels 321 are arranged, a control circuit 322, a vertical scanning circuit 323 having a distribution operation, a horizontal scanning circuit 324, and a pixel signal processing circuit 325. Here, the control circuit 322, the vertical scanning circuit 323, the horizontal scanning circuit 324, and the pixel signal processing circuit 325 are examples of a pixel driving circuit.

The light receiving region 320 is a region in which the plurality of pixels 321 are arranged, and FIG. 2 shows an example in which the pixels 321 are arranged in a two-dimensional matrix in eight rows and eight columns. The pixel 321 accumulates charges corresponding to the amount of light received. For example, the control circuit 322 controls the operations of the component of the distance image sensor 32 in response to an instruction from the timing control unit 41 of the distance image processing unit 4.

The vertical scanning circuit 323 is a circuit that controls the pixels 321 arranged in the light receiving region 320 for each row in accordance with the control from the control circuit 322. The vertical scanning circuit 323 outputs a voltage signal in response to the amount of charge accumulated in each of the charge accumulation units CS of the pixel 321 to the pixel signal processing circuit 325.

The pixel signal processing circuit 325 performs predetermined signal processing (for example, noise suppression processing or A/D conversion processing) on the voltage signals output from the pixel 321 in each of the columns in accordance with the control from the control circuit 322. The horizontal scanning circuit 324 is a circuit that sequentially outputs the signals output from the pixel signal processing circuit 325 in time series in accordance with the control from the control circuit 322. As a result, pixel signals corresponding to the amount of charge accumulated for one frame are sequentially output to the distance image processing unit 4. In the following description, it is assumed that the pixel signal processing circuit 325 performs A/D conversion processing and the pixel signal is a digital signal.

Here, the configuration of the pixels 321 arranged in the light receiving region 320 included in the distance image sensor 32 will be described. FIG. 3 is a circuit diagram showing a configuration example of the pixel 321. The pixel 321 in FIG. 3 is a configuration example including four pixel signal readout units.

The pixel 321 includes one photoelectric conversion element PD, a charge discharge transistor GD, and four pixel signal readout units RU (RU1 to RU4) that output voltage signals from corresponding output terminals O. Each of the pixel signal readout units RU includes a charge transfer transistor G, a floating diffusion FD, a charge accumulation capacitor C, a reset transistor RT, a source follower transistor SF, and a selection transistor SL. The floating diffusion FD, and the charge accumulation capacitor C constitute a charge accumulation unit CS.

In the pixel 321 shown in FIG. 3, a pixel signal readout unit RU1 that outputs a voltage signal from an output terminal O1 includes a charge transfer transistor G1 (transfer MOS transistor), a floating diffusion FD1, a charge accumulation capacitor C1, a reset transistor RT1, a source follower transistor SF1, and a selection transistor SL1. In the pixel signal readout unit RU1, the charge accumulation unit CS1 is configured to include the floating diffusion FD1 and the charge accumulation capacitor C1. The pixel signal readout units RU2, RU3, and RU4 have the same configuration.

The photoelectric conversion element PD is an embedded photodiode that photoelectrically converts incident light to generate a charge in response to the incident light (incident light) and accumulates the generated charge. In the present embodiment, the incident light is incident from the space to be measured. In the pixel 321, the charge generated by the photoelectric conversion of incident light by the photoelectric conversion element PD is distributed to each of the four charge accumulation units CS (CS1 to CS4), and each of the voltage signals in response to the amount of charge of the distributed charge is output to the pixel signal processing circuit 325.

In addition, the configuration of the pixel 321 is not limited to the configuration including the four pixel signal readout units RU (RU1 to RU4) as shown in FIG. 3.

In addition, the configuration of the pixel 321 is not limited to the configuration including the charge discharge transistor GD as shown in FIG. 3.

Here, processing related to a sleep function in the present embodiment, that is, execution of the power saving mode and a function of shifting from the power saving mode to execution of the normal mode will be described.

The power saving mode in the present embodiment is a mode in which a driving method for reducing power consumption is executed. Specific contents of the power saving mode will be described in detail below.

In addition, the normal mode in the present embodiment is a mode in which a driving method for measuring the distance to the subject OB is executed. As a driving method of the pixel 321 in the normal mode, any driving method in the related art may be used. For example, in the normal mode, the distance image processing unit 4 drives the pixel 321, so that charges in response to the amount of light received by the pixel 321 are distributed and accumulated in each of the charge accumulation unit CS of the pixel 321 at an accumulation timing synchronized with an emission timing of emitting the optical pulse PO. The distance image processing unit 4 calculates the distance to the subject OB by using the accumulated signal in response to the amount of charge accumulated in each of the charge accumulation units CS.

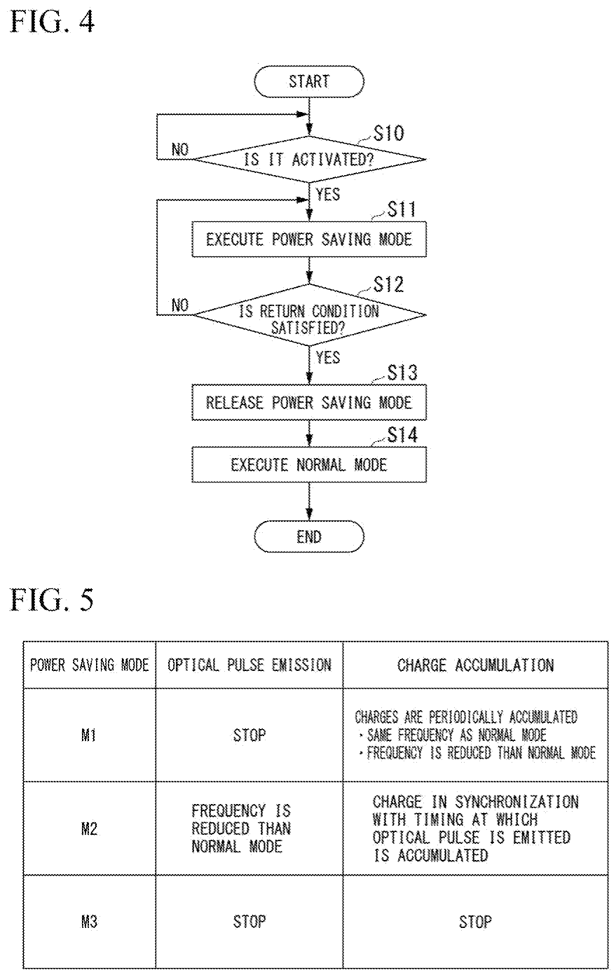

FIG. 4 is a flowchart showing a flow of processing performed by the distance image processing unit 4 according to the embodiment. As shown in FIG. 4, when the distance image capturing device 1 is activated (step S10, YES), first, the distance image processing unit 4 executes the power saving mode (step S11).

Next, the distance image processing unit 4 regularly or irregularly determines whether or not the return condition is satisfied (step S12). The return condition here is, for example, a condition that is set according to the result of executing the power saving mode. Specific contents of the return condition will be described in detail later. In a case where the distance image processing unit 4 is determined that the return condition is satisfied, the distance image processing unit 4 releases the power saving mode (step S13) and executes the normal mode (step S14).

Here, the power saving mode will be described with reference to FIGS. 5 to 9.

FIG. 5 is a table showing the power saving mode. As shown in FIG. 5, the power saving mode has a plurality of modes, a power saving mode M1, a power saving mode M2, and a power saving mode M3. In each power saving mode, operations for each item of optical pulse emission and charge accumulation are set.

In the power saving mode M1, the optical pulse emission is controlled by the distance image processing unit 4 so that the optical pulse PO is not emitted (the optical pulse emission is stopped). In addition, in the power saving mode M1, the charge accumulation is controlled by the distance image processing unit 4 so that the charges are periodically accumulated. Here, a frequency of charge accumulation in the power saving mode M1 may be optionally set as long as charges are accumulated at least periodically. For example, the frequency of charge accumulation may be the same as the normal mode, or may be a frequency smaller than the normal mode. In addition, in the power saving mode M1, the distance image processing unit 4 controls so that signal processing related to distance measurement is not executed.

As a result, in the power saving mode M1, the distance image capturing device 1 operates as an IR camera that captures an image without emitting the optical pulse PO. The IR camera here is a capturing device that outputs image information in which brightness is mapped for each pixel coordinate based on the brightness in response to the amount of light received by the pixel 321 (for example, reflected light RL and/or external light such as sunlight or indoor illumination light).

In the power saving mode M2, the optical pulse emission is controlled by the distance image processing unit 4 so that the frequency of emitting the optical pulse PO is smaller than that in the normal mode. In addition, in the power saving mode M2, charge accumulation is controlled by the distance image processing unit 4 so that the charge accumulation is performed in synchronization with the emission timing at which the optical pulse PO is emitted only in a case where the optical pulse PO is emitted. In addition, in the power saving mode M2, the distance image processing unit 4 controls so that the signal processing related to the distance measurement is not executed. As a result, in the power saving mode M2, the distance image capturing device 1 operates as an IR camera that emits the optical pulse PO to capture an image.

In the power saving mode M3, the optical pulse emission is controlled by the distance image processing unit 4 so that the optical pulse PO is not emitted (stopped). In addition, in the power saving mode M3, the charge accumulation is controlled by the distance image processing unit 4 so that the charge accumulation is not performed. As a result, in the power saving mode M3, the distance image capturing device 1 does not operate as a distance measurement or an IR camera, and is in an operation stop state.

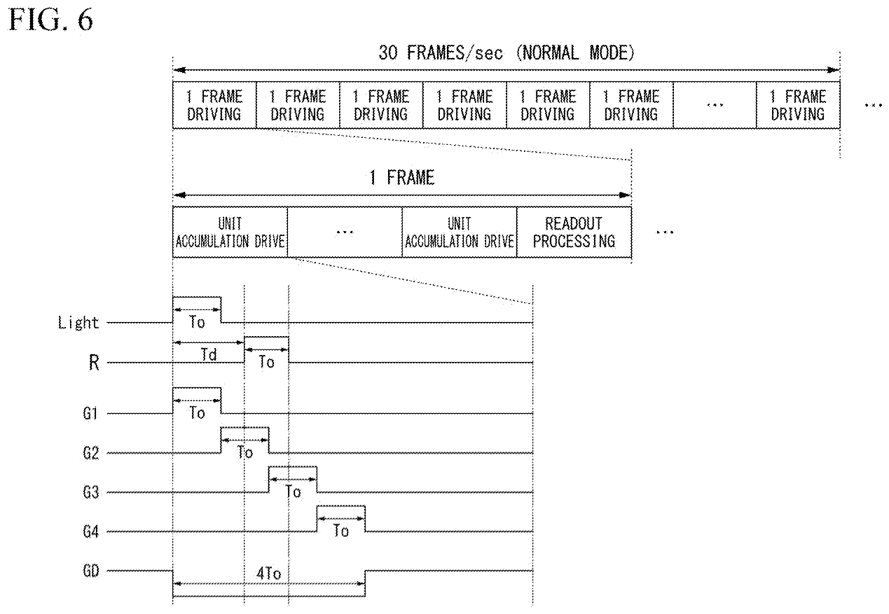

FIG. 6 is a diagram showing the normal mode. As shown in the upper part of FIG. 6, in the normal mode, a plurality of frames are performed per unit time, and the pixel 321 is driven at a frequency of, for example, 30 frames/sec. In addition, as shown in the middle part of FIG. 6, in each frame, readout processing is executed after a unit accumulation drive is repeatedly executed.

An example of a timing chart for driving the pixel 321 in the normal mode is shown in the lower part of FIG. 6. In this timing chart, the timing of emitting the optical pulse PO is shown in the item “Light”, and it is shown that the optical pulse PO is emitted in High and is not emitted in Low. In addition, the timing of receiving the reflected light RL is shown in the item “R”, and it is shown that the reflected light RL is received in High and is not received in Low.

In addition, the timing of accumulating the charges in the charge accumulation unit CS1 is shown in the item “G1”, and it is shown that the charges are accumulated in High and are not accumulated in Low. The timing of accumulating the charges in the charge accumulation unit CS2 is shown in the item “G2”, and it is shown that the charges are accumulated in High and are not accumulated in Low. Similarly, in the items of “G3” and “G4”, the timing of accumulating the charges in the charge accumulation units CS3 and CS4 are shown, and it is shown that the charges are accumulated in High and not accumulated in Low.

In addition, the timing of discharging the charges is shown in the item “GD”, and it is shown that the charges are discharged in High and are not discharged in Low.

As shown in the lower part of FIG. 6, in the normal mode, the distance image processing unit 4 drives the pixels 321 so that charges are sequentially accumulated in each of the charge accumulation units CS1 to CS4 at the accumulation timing synchronized with the emission timing of the optical pulse PO. In the example in this drawing, charges corresponding to the reflected light RL are distributed and accumulated in the charge accumulation units CS2 and CS3.

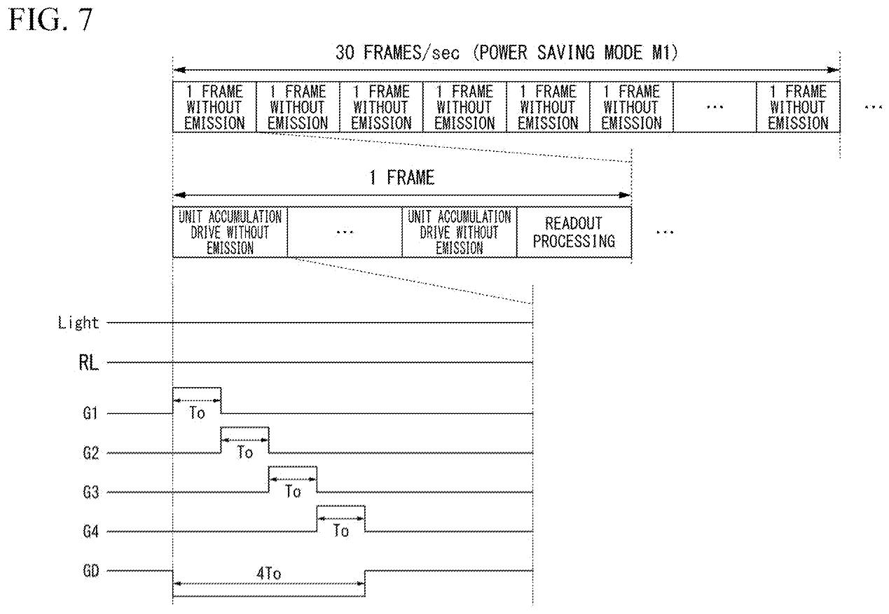

FIG. 7 is a diagram showing the power saving mode M1. As shown in the upper part of FIG. 7, in the power saving mode M1, a plurality of frames are performed per unit time “without emission” in which the optical pulse PO is not emitted. In addition, as shown in the middle part of FIG. 6, in each frame, the readout processing is executed after the unit accumulation drive is repeatedly executed in “without emission” in which the optical pulse PO is not emitted.

An example of a timing chart for driving the pixel 321 in the power saving mode M1 is shown in the lower part of FIG. 7. Since each item in this timing chart is the same as that in the timing chart in the lower part of FIG. 6, a description thereof will be omitted.

As shown in the lower part of FIG. 7, in the power saving mode M1, the distance image processing unit 4 drives the pixels 321 so that charges are sequentially accumulated in each of the charge accumulation units CS1 to CS4 at the accumulation timing synchronized with the emission timing in the normal mode without emitting the optical pulse PO.

In the power saving mode M1, for example, the distance image processing unit 4 acquires accumulated signals SIG1 to SIG4 corresponding to the amount of light received by each of the pixels 321, that is, the amount of charge accumulated in each of the charge accumulation units CS1 to CS4 provided in each pixel, in the readout processing of each frame. The distance image processing unit 4 sets a sum of the acquired accumulated signals SIG1 to SIG4 as a pixel value of each pixel in the IR image. The distance image processing unit 4 generates an IR image for each frame, and, for example, in a case where a pixel value of each pixel in the IR image changes, determines that a moving object enters the angle of view of the IR image, that is, the moving object is detected to release the power saving mode M1. For example, the distance image processing unit 4 determines that a moving object is present in the space to be measured, when a change in the pixel value in the IR image, that is, the pixel value corresponding to the amount of light received by the pixel 321 is a threshold value or greater. Here, the fact that the amount of change in the pixel value in the IR image is the threshold value or greater is an example of the “return condition”.

Here, although the case where the pixel value in the IR image is the sum of the accumulated signals SIG1 to SIG4 has been described as an example, the present invention is not limited thereto. For example, a value obtained by adding the absolute value of the difference between the accumulated signals SIG2 and SIG4 to the absolute value of the difference between the accumulated signals SIG1 and SIG3 may be set as the pixel value in the IR image. Alternatively, the signal value of the accumulated signal SIG1 may be the pixel value in the IR image. In the power saving mode M1, at least a value in which the light received by the pixel 321, for example, the amount of light of external light such as sunlight or indoor illumination light is reflected may be used as the pixel value in the IR image.

In addition, FIG. 7 shows the timing chart corresponding to the case where the emission of the optical pulse PO is stopped at the same accumulation timing as the driving of the pixel 321 by the normal mode in FIG. 6. However, the present invention is not limited thereto, and when driving the pixel 321 so that charges are sequentially accumulated in each of the charge accumulation units CS1 to CS4, the length of time for accumulating charges in the pixel 321 (accumulation time) may be different from that in the normal mode.

In the normal mode, since the optical pulse PO is emitted and the reflected light thereof is received, the accumulation time and the number of times of accumulation in which the charges are repeatedly accumulated in one frame may be limited such that the amount of charge to be accumulated in the charge accumulation unit CS is not saturated. On the other hand, in the power saving mode M1 or the like, in a case where the optical pulse PO is not emitted, only external light is received without receiving the reflected light. Therefore, as a configuration for performing driving with the accumulation time set longer than that of the normal mode, it is conceivable to adopt a configuration in which the signal amount of the accumulated signal is increased by increasing the amount of charge accumulated in the charge accumulation unit CS. As a result, it is easy to increase the amount of change in the pixel value according to the presence or absence of the moving object and to set the threshold value for determining the presence or absence of the moving object.

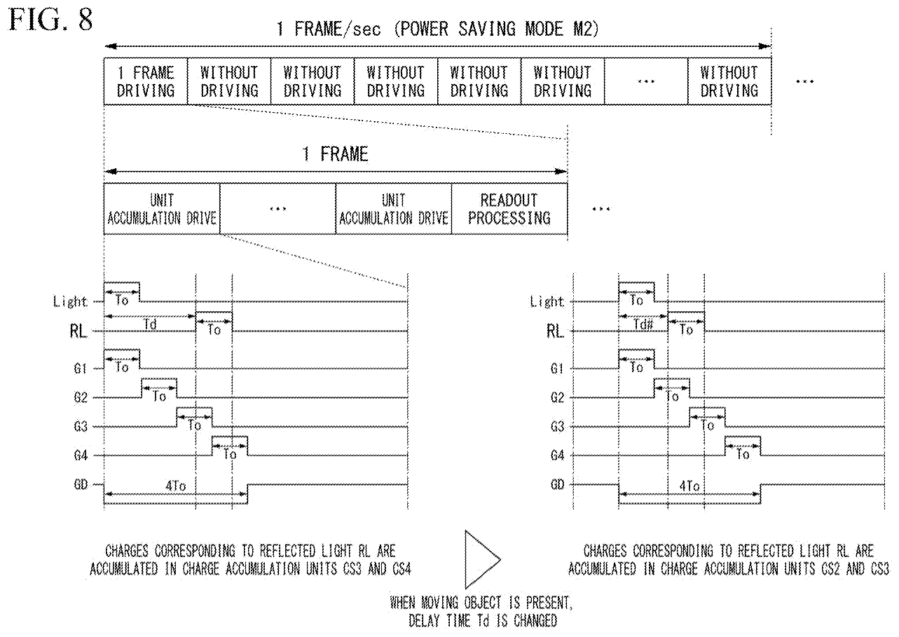

FIG. 8 is a diagram showing the power saving mode M2. As shown in the upper and middle parts of FIG. 8, in the power saving mode M2, the pixel 321 is driven in the same manner as in the normal mode for only one frame, at the same frequency as that in the normal mode, for example, 30 frames/sec, and the pixel 321 is not driven for the remaining time.

An example of a timing chart for driving the pixel 321 in the power saving mode M2 is shown in the lower part of FIG. 8. Since each item in this timing chart is the same as that in the timing chart in the lower part of FIG. 6, a description thereof will be omitted.

As shown in the lower part of FIG. 8, in the frame for driving the pixel 321 in the same manner as in the normal mode, for example, in a case where there is no moving object, the reflected light RL reflected by a wall or the like in the space to be measured is received after a certain delay time Td elapses from the emission timing at which the optical pulse PO is emitted. In this case, charges corresponding to the reflected light RL are accumulated in the specific charge accumulation units CS, for example, the charge accumulation units CS3 and CS4.

On the other hand, in a case where the moving object enters the space to be measured, in a frame in which the pixel 321 is driven in the same manner as in the normal mode, the reflected light RL reflected from the moving object is received after a delay time Td # elapses from the emission timing at which the optical pulse PO was emitted. In this case, since the delay time is changed, the charges corresponding to the reflected light RL are accumulated in the charge accumulation units CS different from those of the previous times, for example, the charge accumulation units CS2 and CS3.

In the power saving mode M2, for example, the distance image processing unit 4 acquires accumulated signals SIG1 to SIG4 corresponding to the amount of charge accumulated in each of the charge accumulation units CS1 to CS4 for each of the pixels 321, in the readout processing of the frame for driving the pixel 321 in the same manner as in the normal mode. The distance image processing unit 4 specifies an accumulated signal including a signal corresponding to the reflected light RL, among the acquired accumulated signals SIG1 to SIG4.

For example, the distance image processing unit 4 specifies two accumulated signals having large signal values as accumulated signals including a signal corresponding to the reflected light RL, among the accumulated signals SIG1 to SIG4. For example, in a case where the reflected light RL is received at the timing shown in the timing chart on the left side in the lower part of FIG. 8, the distance image processing unit 4 specifies the accumulated signals SIG3 and SIG4 as accumulated signals including a signal corresponding to the reflected light RL, among the accumulated signals SIG1 to SIG4.

In a case where the accumulated signal corresponding to the reflected light RL changes, the distance image processing unit 4 determines that a moving object enters the space to be measured, that is, the moving object is detected, and releases the power saving mode M2.

For example, in a case where the timing is changed to the timing shown in the timing chart from the left side to the right side in the lower part of FIG. 8, the distance image processing unit 4 determines that the accumulated signals including a signal corresponding to the reflected light RL is changed from the accumulated signals SIG3 and SIG4 to the accumulated signals SIG2 and SIG3, among the accumulated signals SIG1 to SIG4. In this case, the distance image processing unit 4 determines that a moving object is detected, and releases the power saving mode M2. For example, in a case where a change in the amount of charge accumulated in the charge accumulation unit CS is a threshold value or greater, the distance image processing unit 4 determines that a moving object is present in the space to be measured. Here, the fact that a change in the accumulated signal corresponding to the reflected light RL, that is, a change in the amount of charge accumulated in the charge accumulation unit CS, is the threshold value or greater is an example of the “return condition”.

In addition, in the power saving mode M2, similar to the power saving mode M1, when the amount of change in the pixel value corresponding to the amount of light received by each of the pixels 321 is the threshold value or greater, it may be determined that a moving object is present in the space to be measured. Here, the fact that the amount of change in the pixel value in the IR image is the threshold value or greater is an example of the “return condition”.

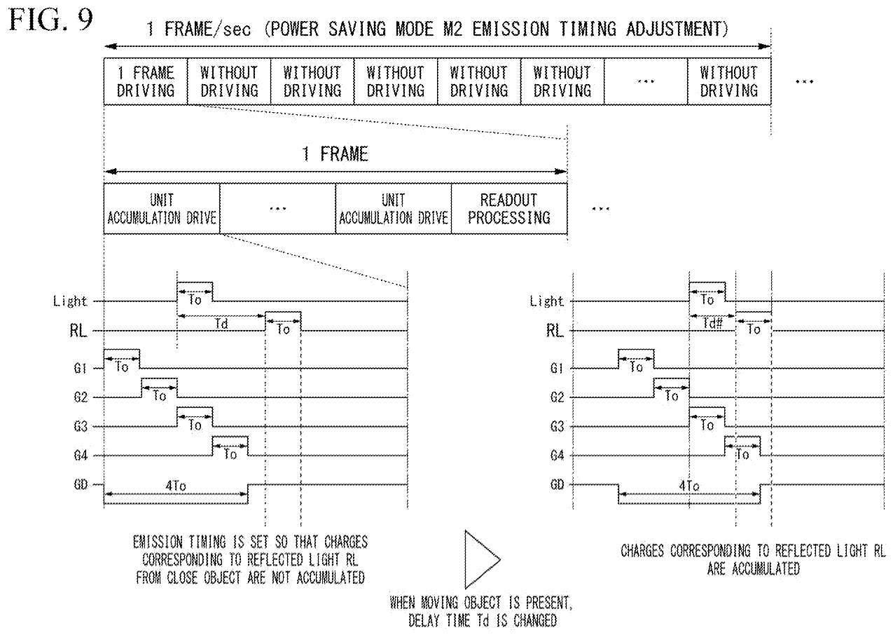

FIG. 9 is a diagram showing a modification example (variation) of the power saving mode M2. Since the same one as the upper part and the middle part in FIG. 8 are shown in the upper part and the middle part of FIG. 9, a description thereof will be omitted.

An example of a timing chart for driving the pixel 321 in the modification example of the power saving mode M2 is shown in the lower part of FIG. 9. Since each item in this timing chart is the same as that in the timing chart in the lower part of FIG. 6, a description thereof will be omitted.

As shown in the lower part of FIG. 9, in the modification example of the power saving mode M2, the emission timing (the timing of emitting the optical pulse PO) in the frame for driving the pixel 321 as in the normal mode is delayed compared to the normal mode. In the example in this drawing, the optical pulse PO is emitted at the same timing as the timing for accumulating the charges in the charge accumulation unit CS3 in the normal mode. In this case, the reflected light RL is received later than the timing of accumulating the charges in each of the charge accumulation units CS1 to CS4. Therefore, the charge corresponding to the reflected light RL is discharged without being accumulated in the charge accumulation unit CS.

On the other hand, in a case where the moving object enters the space to be measured, as in the case in FIG. 8, the timing of receiving the reflected light RL in the frame for driving the pixel 321 as in the normal mode changes, and charges corresponding to the reflected light RL discharged until the previous time are accumulated in the charge accumulation unit CS, for example, the charge accumulation unit CS4.

In the modification example of the power saving mode M2, for example, the distance image processing unit 4 acquires accumulated signals SIG1 to SIG4 corresponding to the amount of charge accumulated in each of the charge accumulation units CS1 to CS4 for each of the pixels 321, in the readout processing of the frame for driving the pixel 321 in the same manner as in the normal mode. The distance image processing unit 4 determines whether or not any of the acquired accumulated signals SIG1 to SIG4 include a signal corresponding to the reflected light RL.

For example, in a case where the difference between the maximum value and the minimum value of the accumulated signals SIG1 to SIG4 is less than a threshold value, the distance image processing unit 4 determines that none of the accumulated signals SIG1 to SIG4 includes a signal corresponding to the reflected light RL. On the other hand, in a case where the difference between the maximum value and the minimum value of the accumulated signals SIG1 to SIG4 is the threshold value or greater, it is specified that any of the accumulated signals SIG1 to SIG4 includes a signal corresponding to the reflected light RL.

In a case where the state changes from a state where none of the accumulated signals SIG1 to SIG4 includes a signal corresponding to the reflected light RL to a state where a signal corresponding to the reflected light RL is included, the distance image processing unit 4 determines that a moving object enters the space to be measured, that is, the moving object is detected, and releases the power saving mode M2.

For example, in a case where the timing is changed to the timing shown in the timing chart from the left side to the right side in the lower part of FIG. 9, the distance image processing unit 4 determines that the state is changed from a state where none of the accumulated signals SIG1 to SIG4 includes a signal corresponding to the reflected light RL to a state where the accumulated signal SIG4 includes a signal corresponding to the reflected light RL. In this case, the distance image processing unit 4 determines that a moving object is detected, and releases the modification example of the power saving mode M2. For example, in a case where a change in the amount of charge accumulated in the charge accumulation unit CS is a threshold value or greater, the distance image processing unit 4 determines that a moving object is present in the space to be measured. Here, the fact that a change from a state where a signal corresponding to the reflected light RL is not included in the accumulated signal to a state where the signal is included, that is, a change in the amount of charge accumulated in the charge accumulation unit CS, is the threshold value or greater, is an example of the “return condition”.

Here, In the above description, in the power saving mode M2, the case where the power saving mode M2 (or a modification example of power saving mode M2) is released based on the signal value of the accumulated signals SIG1 to SIG4 corresponding to the amount of charge accumulated in each of the charge accumulation units CS1 to CS4 is described as an example. However, the present invention is not limited thereto.

For example, the distance image processing unit 4 may be configured to calculate the distance using the signal values of the accumulated signals SIG1 to SIG4 in the power saving mode M2 and determine the presence or absence of the moving object based on the amount of change in the calculated distance. In this case, although a processing load for calculating a distance increases, there is an advantage that distance images can be periodically obtained while a frequency is lower than that in a normal mode during the power saving mode M2 is executed.

In the power saving mode M3, the operation of the distance image capturing device 1 is stopped. Therefore, it is not possible to determine whether or not the return condition is satisfied, from a result of signal processing related to the accumulated signal in the distance image capturing device 1.

Therefore, in the power saving mode M3, the distance image processing unit 4 controls so that the power saving mode M3 is released in response to a notification from an external device provided outside the distance image capturing device 1. The external device may be any device that can detect the presence or absence of the moving object in the space, and that is communicably connected to the distance image capturing device 1. For example, as the external device, another distance image capturing device, such as a line sensor that detects a moving object, or a human sensor can be applied.

Specifically, in a case where the presence or absence of a moving object in the space to be measured is detected and the external device is determined that the moving object is present, the external device transmits a control signal to the distance image capturing device 1 to release the power saving mode. The distance image processing unit 4 releases the power saving mode M3 in a case where the control signal for releasing the power saving mode is acquired from the external device in the power saving mode M3.

Alternatively, in the power saving mode M3, the distance image capturing device 1 may release the power saving mode M3 in a case where a predetermined time elapses after the power saving mode M3 is executed. In this case, the distance image capturing device 1 sets a timer when the power saving mode M3 is executed, and releases the power saving mode M3 when it is notified that a predetermined time is measured by the set timer.

In addition, a configuration may be adopted in which the power saving mode in the distance image capturing device 1 is released based on the operation of an external device provided with the distance image capturing device 1. For example, in a system in which the distance image capturing device 1 is provided in a moving object such as an automatic guided vehicle (AGV) or a mobile robot, when the moving object such as the AGV is temporarily stopped, a configuration is considered in which the power saving mode is executed in the distance image capturing device 1, and the moving object such as the AGV starts to move, and the power saving mode in the distance image capturing device 1 is released.

Not only in the power saving mode M3 but also in the power saving modes M1 and M2, the power saving mode may be released by a notification from the external device, a timer, or the like. The fact that the notification is received from the external device is an example of the “return condition”. In addition, the fact that the notification is received by the timer is an example of the “return condition”.

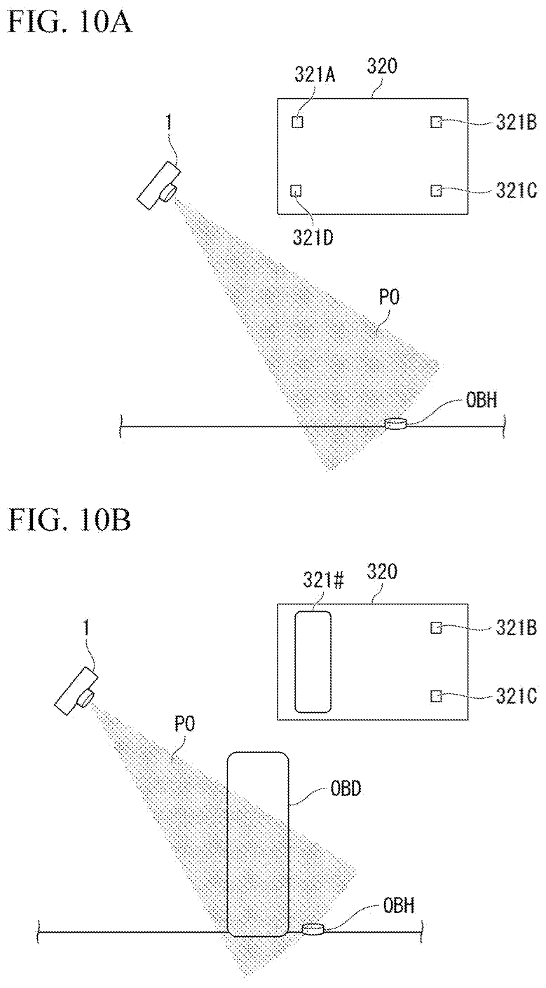

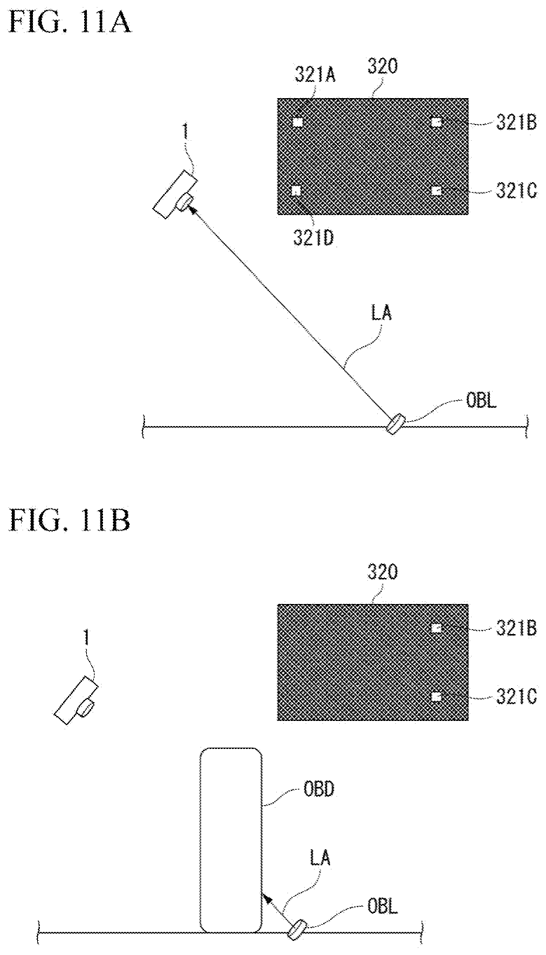

Here, a measurement environment of the distance image capturing device 1 will be described with reference to FIG. 10 (FIGS. 10A and 10B) and FIG. 11 (FIGS. 11A and 11B). FIGS. 10 and 11 are diagrams showing the measurement environment according to the embodiment.

FIG. 10 schematically shows an example in which a reflecting object OBH is disposed in the space to be measured. The reflecting object OBH is an object that reflects light, and is, for example, an object that retroreflectively reflects, such as a sign, or an object with high reflectance, such as a white wall or a mirror. By disposing the reflecting object OBH in the space to be measured, it is possible to detect the presence or absence of the moving object when the power saving mode is executed according to a light receiving status of the light arriving from the reflecting object OBH.

Here, the case applied to the power saving mode in which the optical pulse PO is emitted, that is, the power saving mode M2 will be described as an example, and such a measurement environment for disposing the reflecting object OBH may be applied to the power saving mode M1.

For example, as shown in FIG. 10A, in a case where the moving object is not present in the space to be measured, the reflected light RL arriving from the reflecting object OBH is received by the pixel 321 whenever the distance image capturing device 1 emits the optical pulse PO. The distance image processing unit 4 acquires an accumulated signal corresponding to an amount of light received in a specific pixel 321 in the light receiving region 320, for example, four pixels 321A to 321D in FIG. 10A.

For example, as shown in FIG. 10B, in a case where the moving object (object OBD) enters a space to be measured, when the distance image capturing device 1 emits the optical pulse PO, the reflected light RL arriving from the object OBD is received by the pixel 321. In this case, the reflecting object OBH becomes a shadow of the object OBD, and the reflected light from the reflecting object OBH is not received by a part of the pixels 321 in the light receiving region 320. That is, due to the entering of the moving object, the accumulated signal in a part of the pixels 321 in the light receiving region 320 changes.

In the example shown in FIG. 10B, in the light receiving region 320, the pixel 321 # that is a pixel group received the reflected light RL arriving from the object OBD outputs an accumulated signal different from that in a case where the object OBD is not present. On the other hand, the pixels 321B and 321C, which are the pixels that receive the reflected light RL arriving from the reflecting object OBH, output the same accumulated signal as that in a case where the object OBD is not present, regardless of the presence or absence of the object OBD.

Using such properties, in a case where an accumulated signal corresponding to the amount of light received by a specific pixel 321, for example, four pixels 321A to 321D in FIG. 10A changes, the distance image processing unit 4 releases the power saving mode M2, assuming that the moving object is detected. For example, the distance image processing unit 4 determines that a moving object is present in the space to be measured, when a change in the pixel value in the IR image, that is, the pixel value corresponding to the amount of light received by the pixel 321 is a threshold value or greater. Here, the fact that the amount of change in the pixel value in a specific pixel 321 is a threshold value or greater is an example of the “return condition”.

FIG. 11 schematically shows an example in which the light-emitting object OBL is disposed in the space to be measured. The light-emitting object OBL is an object that emits light, such as a light emitting diode (LED) that emits infrared light or the like. By disposing the light-emitting object OBL in the space to be measured, it is possible to detect the presence or absence of the moving object when the power saving mode is executed according to a light receiving status of the light arriving from the light-emitting object OBL.

Here, the case applied to the power saving mode in which the optical pulse PO is not emitted, that is, the power saving mode M1 will be described as an example, and such a measurement environment for disposing the light-emitting object OBL may be applied to the power saving mode M2.

For example, as shown in FIG. 11A, in a case where the moving object is not present in the space to be measured, light LA arriving from the light-emitting object OBL is received by the pixel 321 in the distance image capturing device 1. The distance image processing unit 4 acquires an accumulated signal corresponding to an amount of light received in a specific pixel 321, for example, four pixels 321A to 321D in FIG. 11A.

For example, as shown in FIG. 11B, in a case where the moving object (object OBD) enters a space to be measured, the light-emitting object OBL becomes a shadow of the object OBD, and the light LA from the light-emitting object OBL is no longer received by a part of the pixels 321 in the light receiving region 320. That is, due to the entering of the moving object, the accumulated signal in a part of the pixels 321 in the light receiving region 320 changes.

In the example shown in FIG. 11, in the light receiving region 320, the pixel 321 which no longer receives the light LA due to the light LA being blocked by the object OBD outputs an accumulated signal different from that in the case where the object OBD is not present. On the other hand, the pixels 321B and 321C, which are the pixels that receive the light LA, output the same accumulated signal as that in a case where the object OBD is not present, regardless of the presence or absence of the object OBD.

Using such properties, in a case where an accumulated signal corresponding to the amount of light received by a specific pixel 321, for example, four pixels 321A to 321D in FIG. 11A changes, the distance image processing unit 4 releases the power saving mode M1, assuming that the moving object is detected. For example, the distance image processing unit 4 determines that a moving object is present in the space to be measured, when a change in the pixel value in the IR image, that is, the pixel value corresponding to the amount of light received by the pixel 321 is a threshold value or greater. Here, the fact that the amount of change in the pixel value in a specific pixel 321 is a threshold value or greater is an example of the “return condition”.

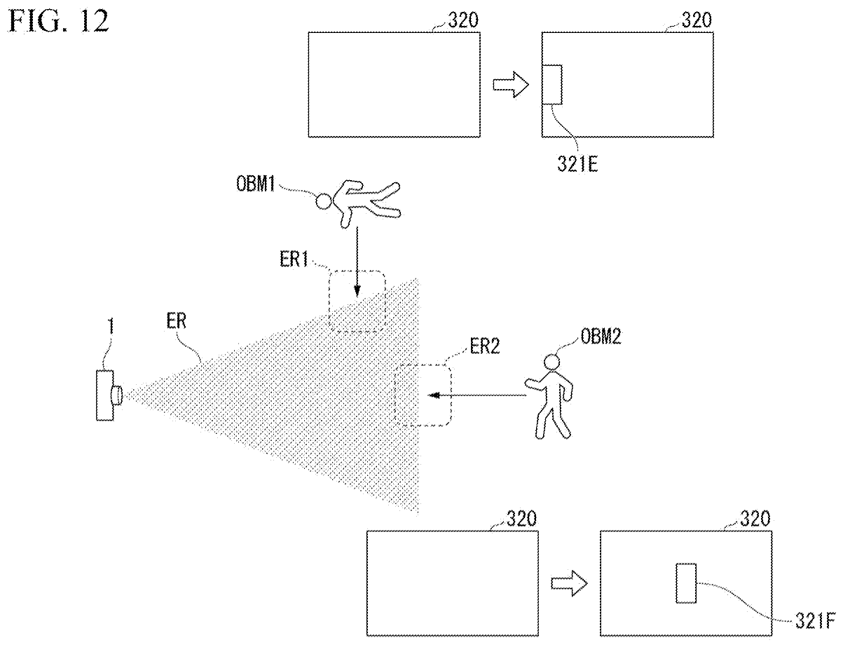

Here, a measurement environment of the distance image capturing device 1 will be described with reference to FIG. 12. FIG. 12 is a diagram showing the measurement environment according to the embodiment.

FIG. 12 schematically shows a state where a moving object OBM (moving object OBM1 or OBM2) such as a walking person enters a space ER to be measured.

As shown in FIG. 12, for example, in a case where the moving object OBM1 enters from an end portion ER1 of the space ER, the accumulation state of the charges in the pixel 321E arranged at the end portion in the light receiving region 320 changes depending on the entering of the moving object OBM1. That is, the distance image capturing device 1 can detect whether or not the moving object OBM1 enters according to a change in the accumulation state of the pixel 321E.

On the other hand, in a case where the moving object OBM2 enters from the end portion ER2 far from the center of the space ER, the accumulation state of the charges in the pixel 321F arranged in the central portion of the light receiving region 320 changes depending on the entering of the moving object OBM2. That is, the distance image capturing device 1 can detect whether or not the moving object OBM2 enters according to a change in the accumulation state of the pixel 321F.

Using such properties, the distance image processing unit 4 may monitor only the pixel 321 arranged in the region corresponding to an entering path of a moving object entering the space ER, and determine that the moving object is detected in a case where the accumulated signal in the monitored pixel 321 changes.

In this case, for example, the installation position and the capturing direction of the distance image capturing device 1 are adjusted so that the lateral direction (horizontal direction) or the longitudinal direction (vertical direction) in the angle of view of the distance image captured by the distance image capturing device 1 is the same as the direction of the passage through which people are expected to pass. Moreover, in the power saving mode, the distance image capturing device 1 drives not all of the pixels 321 arranged in the light receiving region 320, but only a part of the pixels 321 corresponding to the entering path of the moving object. In a case where the amount of change in the accumulated signal in the driven pixel 321 is the threshold value or greater, the distance image processing unit 4 is determined that a moving object is detected.

In this manner, it is possible to suppress the electric power consumed in the power saving mode by driving only a part of the pixels 321 instead of all of the pixels 321 arranged in the light receiving region 320. In addition, it is also possible to improve the detection speed by driving only a part of the pixels 321 and detecting the presence or absence of the moving object from the accumulated signal of the driven pixels 321.

For example, in a case where the pixels 321 are arranged on a two-dimensional plane extending over 640 vertical columns and 480 horizontal rows in the light receiving region 320, only the pixels 321 arranged in a region corresponding to 10 vertical columns and 100 horizontal rows in the upper, lower, left, and right directions of the light receiving region 320 are driven as a part of the pixels 321.

In such a power saving mode in which only a part of the pixels 321 are driven, the distance image capturing device 1 may or may not emit the optical pulse PO.

In addition, in such a power saving mode in which only a part of the pixels 321 are driven, the reflecting object OBH as shown in FIG. 10, or/and the light-emitting object OBL as shown in FIG. 11 may be installed in the entering path of the moving object.

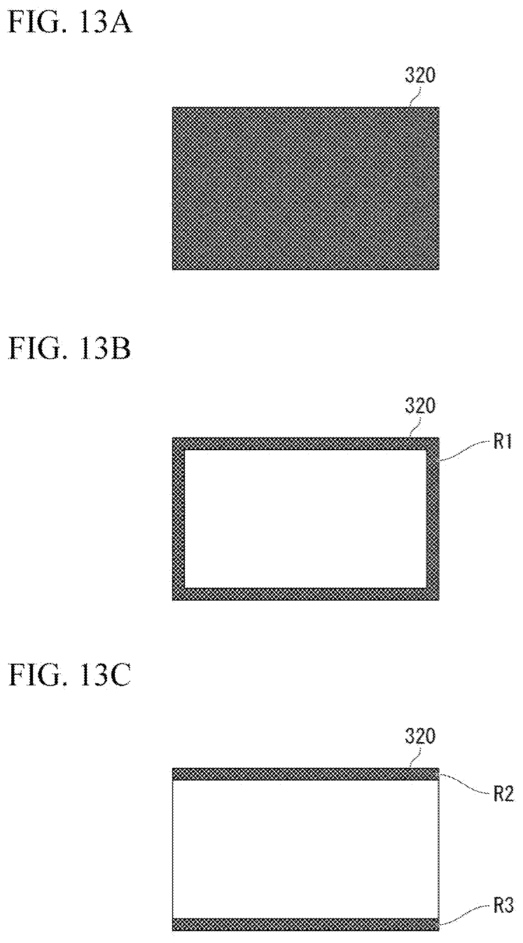

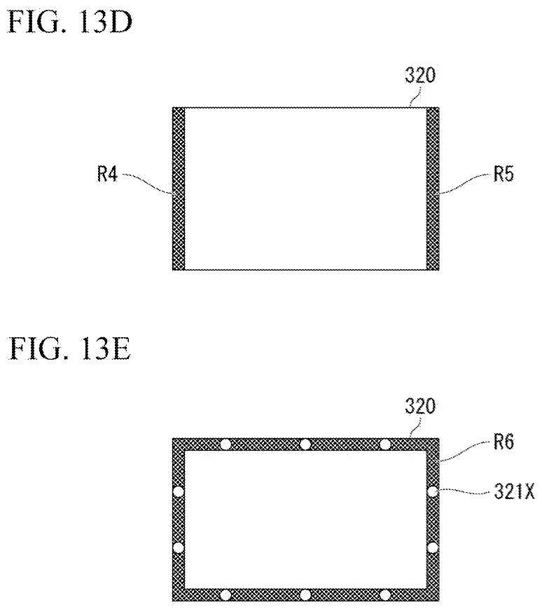

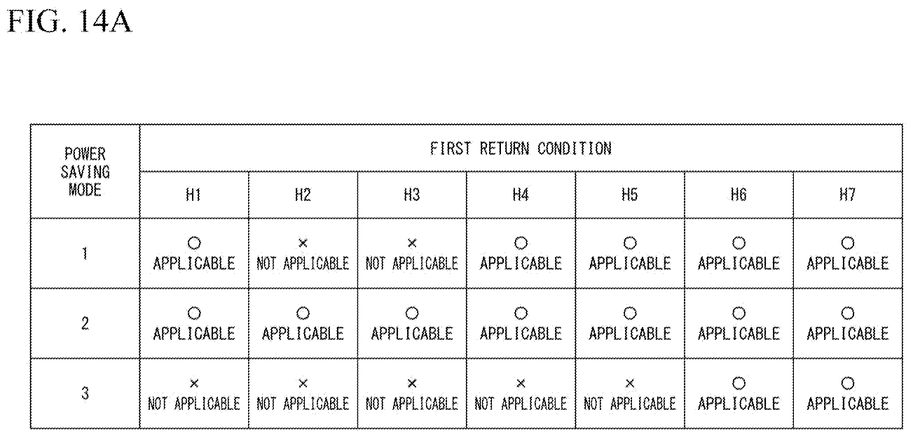

FIG. 13 (FIG. 13A to FIG. 13E) is a diagram showing an example of a part of the pixels 321 driven in the power saving mode. A patterned region in the light receiving region 320 of FIG. 13 indicates the region in which the driven pixels 321 are arranged. In addition, in the patterned region in FIG. 13, the pixel 321 indicated by the circle is the pixel 321 that receives light arriving from a specific object (reflecting object OBH or/and light-emitting object OBL).

For example, as shown in FIG. 13A, the distance image processing unit 4 drives all the pixels 321 arranged in the light receiving region 320 in the normal mode.

As shown in FIG. 13B, in the power saving mode, the distance image processing unit 4 drives only the pixels 321 arranged in a region R1 corresponding to the outer peripheral portion in the light receiving region 320.

Alternatively, as shown in FIG. 13C, in the power saving mode, the distance image processing unit 4 drives only the pixels 321 arranged in a region R2 corresponding to the upper portion and a region R3 corresponding to the lower portion of the light receiving region 320.

Alternatively, as shown in FIG. 13D, in the power saving mode, the distance image processing unit 4 drives only the pixels 321 arranged in a region R4 corresponding to the left portion and a region R5 corresponding to the right portion in the light receiving region 320.

In addition, as shown in FIG. 13E, in the power saving mode, in the distance image processing unit 4, the reflecting object OBH or/and the light-emitting object OBL may be installed in the measurement space so that a part of the driven pixels 321 receive light arriving from the reflecting object OBH or/and the light-emitting object OBL.

The present invention is not limited to the examples of FIG. 13 (FIGS. 13A to 13E). In the power saving mode, at least a part of the pixels 321, instead of all of the pixels 321 arranged in the light receiving region 320, may be driven. For example, only the pixels 321 arranged in the region of approximately ¼ of the upper portion on the right side of the light receiving region 320 may be configured to be driven in the power saving mode.

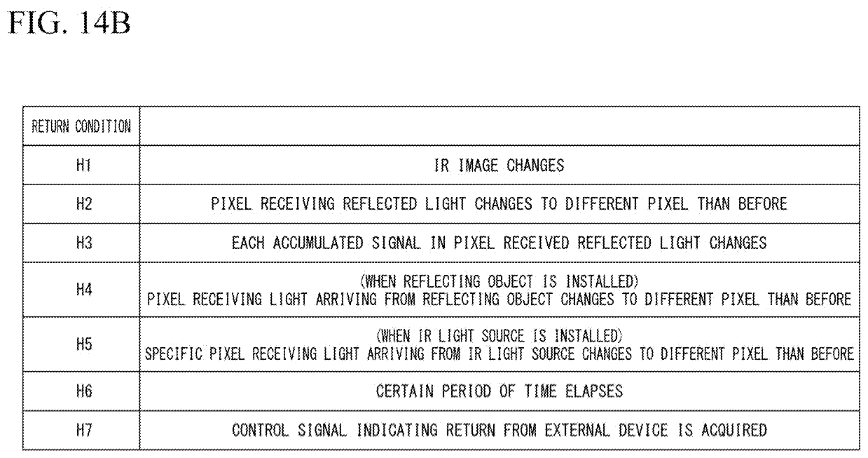

Here, the return conditions will be described with reference to FIG. 14 (FIGS. 14A and 14B). FIG. 14 is a table showing processing performed by the distance image processing unit 4 according to the embodiment.

FIG. 14A shows a correspondence relationship between the power saving mode and the return condition. FIG. 14B shows specific contents of the return condition.

As shown in FIG. 14A, in the power saving mode M1, conditions that can be applied as the return condition are return conditions H1 and H4 to H7. In the power saving mode M2, conditions that can be applied as the return condition are the return conditions H1 to H7. In the power saving mode M3, conditions that can be applied as the return condition are the return conditions H6 to H7.

As shown in FIG. 14B, the return condition H1 is a condition under which the IR image changes, and can be applied to the power saving mode in which the distance image capturing device 1 is operated as an IR camera, that is, to the power saving modes M1 and M2.

The return condition H2 is a condition under which the pixel receiving the reflected light RL changes, and can be applied to the power saving mode in which the optical pulse PO is emitted and the reflected light RL is received, that is, to the power saving mode M1.

The return condition H3 is a condition under which the amount of charge accumulated in the charge accumulation units CS1 to CS4 in the pixel received the reflected light RL change, and can be applied to the power saving mode in which the optical pulse PO is emitted and the reflected light RL is received, that is, to the power saving mode M1.

The return condition H4 is a condition under which the pixel received light arriving from the reflecting object OBH changes in the measurement environment in which the reflecting object OBH is disposed, and can be applied to the power saving mode in which charge accumulation is performed, that is, to the power saving modes M1 and M2.

The return condition H5 is a condition under which the pixel received light arriving from the light-emitting object OBL changes in the measurement environment in which the light-emitting object OBL is disposed, and can be applied to the power saving mode in which charge accumulation is performed, that is, to the power saving modes M1 and M2.

The return condition H6 is a condition in which a predetermined time elapses after the power saving mode is executed, and can be applied to all the power saving modes, that is, the power saving modes M1 to M3.

The return condition H7 is a condition under which the release of the power saving mode is notified from the external device, and can be applied to all the power saving modes, that is, the power saving modes M1 to M3.

In the above description, the case where the power saving mode is executed at the time of activation is described as an example, and the present invention is not limited thereto. In a case where the normal mode is executed at the time of activation, the presence or absence of the moving object is detected in the normal mode, and it is determined that there is no moving object in the space to be measured, the mode may be shifted to the power saving mode. In the normal mode, any method can be adopted as a method of determining whether or not there is a moving object. For example, it is possible to determine that there is a moving object based on the distance to the object measured in the normal mode and the history of the position of the object, in a case where the distance to the object and/or the position of the object changes.

### (Regarding Aspect of Selecting Power Saving Mode)

Here, an aspect of selecting the power saving mode will be described.

In a case where the distance image capturing device 1 is incorporated as a distance sensor in a moving object such as a mobile robot to control the movement of the moving object, the normal mode or any one of the power saving modes M1 to M3 may be selected based on the situation of the moving object. For example, it is assumed that there is a system in which a distance image capturing device 1 is incorporated into a cleaning robot that moves while performing cleaning, and the movement direction of the moving object is controlled based on the measurement result of the distance to an obstacle by the distance image capturing device 1. In this system, in a case where the cleaning robot is connected to a provided charging station, the distance image processing unit 4 selects the power saving mode M3 and enters a state where the operation is stopped. In a case where the cleaning robot is moving, the distance image processing unit 4 first selects the power saving mode M1 or M2, and detects the presence or absence of a moving object. In a case where the distance image processing unit 4 is determined that there is a moving object in the measurement space in the power saving mode M1 or M2, the distance image processing unit 4 selects the normal mode and measures the distance to the moving object (obstacle). In addition, in a case where the cleaning robot detects an obstacle such as a wall and changes the movement direction, from the start to the end of the change of the movement direction, the distance image processing unit 4 may select the power saving mode M3 and enter a state where the operation is stopped.

In addition, in a case where the power saving mode M1 or M2 is selected, the distance image processing unit 4 may select either the power saving mode M1 or M2 based on a capturing environment. For example, in the case of a capturing environment where the sunlight or ambient light is emitted such as in the daytime, the power saving mode M1 is selected as a power saving mode in which the optical pulse PO is not emitted. On the other hand, in the case of a capturing environment where the sunlight or ambient light is not emitted such as at night, the power saving mode M2 is selected as a power saving mode in which the optical pulse PO is emitted.

### (Method for Detecting Presence or Absence of Moving Object in Power Saving Mode M2)

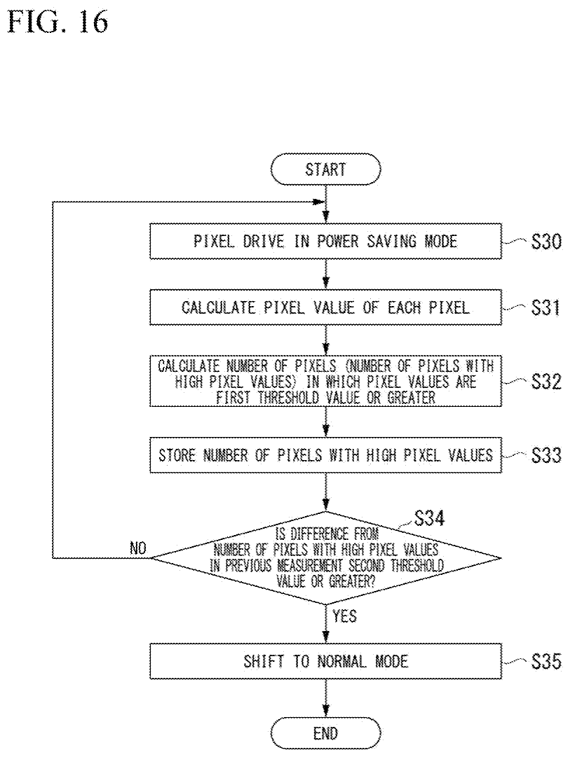

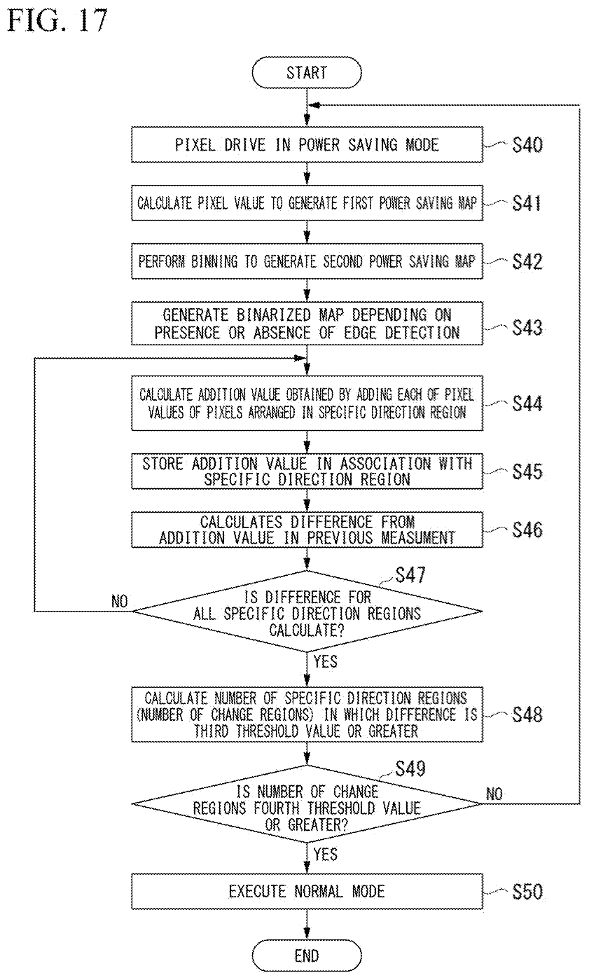

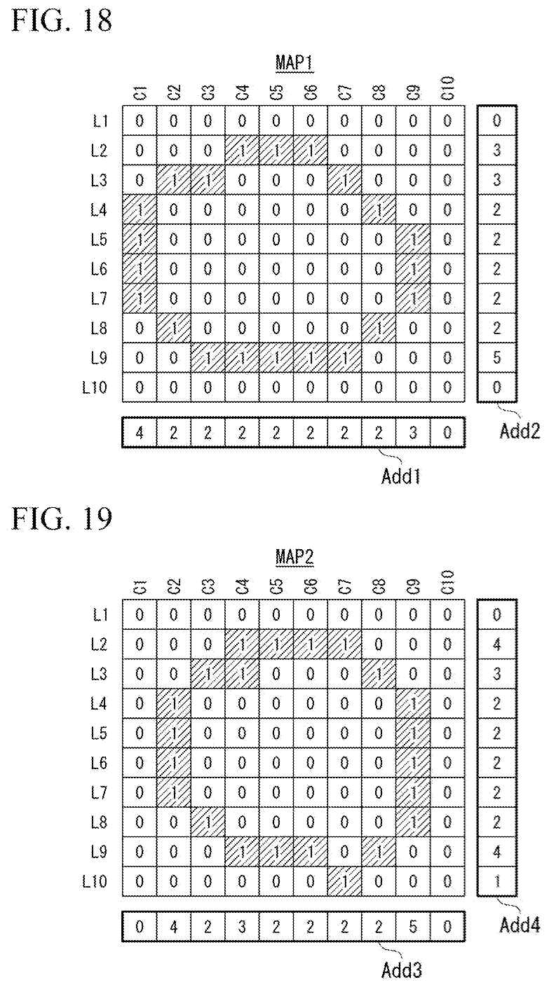

Here, a method for detecting the presence or absence of a moving object in the power saving mode M2 will be described with reference to FIGS. 16 to 21. FIG. 16 is a flowchart showing an example of a flow of processing of determining the presence or absence of a moving object, which is performed by the distance image processing unit 4 according to the embodiment. FIG. 17 is a flowchart showing another example of a flow of the processing of determining the presence or absence of the moving object, which is performed by the distance image processing unit 4 according to the embodiment. FIGS. 18 to 21 are diagrams showing the processing performed in the flowchart of FIG. 17.

Hereinafter, it is assumed that the plurality of pixels 321 are driven in the power saving mode M2. For example, as shown in FIG. 13, a part of the plurality of pixels 321 among the pixel group forming the distance image is driven in the power saving mode M2.

In addition, in the following description, as the pixel value of the pixel 321 driven in the power saving mode M2, a value corresponding to the pixel value corresponding to the amount of charge accumulated in one specific charge accumulation unit CS among the plurality of charge accumulation units CS provided in the pixel 321 is used. However, the present invention is not limited thereto. For example, a value corresponding to the pixel value corresponding to the amount of light of the reflected light incident on the pixel 321 may be used by using all of the plurality of charge accumulation units CS provided in the pixel 321.

Any method can be adopted as a method of calculating the amount of light of the reflected light incident on the pixel 321. For example, the absolute value (first absolute value) of the difference between the accumulated signals SIG1 and SIG3 corresponding to the amount of charge accumulated in each of the charge accumulation units CS1 and CS3 can be calculated, the absolute value (second absolute value) of the difference between the accumulated signals SIG2 and SIG4 corresponding to the amount of charge accumulated in each of the charge accumulation units CS2 and CS4 can be calculated, and an addition value of the first absolute value and the second absolute value can be set as a pixel value corresponding to the amount of light of the reflected light. Here, as shown in FIG. 6, the unit emission time To for emitting the optical pulse is the same as the unit accumulation time To for accumulating the charge in each of the charge accumulation units CS in the unit accumulation drive, and it is assumed that charges are accumulated in each of the charge accumulation units CS in the order of charge accumulation units CS1, CS2, CS3, and CS4.

First, an example of the flow of processing of determining the presence or absence of a moving object will be described using FIG. 16.

Step S30: The distance image processing unit 4 drives the pixel 321 in the power saving mode M2.

Step S31: The pixel value of the pixel 321 driven in the power saving mode M2 is calculated.

Step S32: The distance image processing unit 4 calculates the number of pixels in which pixel values are a first threshold value or greater (hereinafter, referred to as the number of pixels with high pixel values). The first threshold value may be a fixed value, or may be a variable value set according to the amount of light of external light incident on the pixel 321. The amount of light of external light incident on the pixel 321 can be calculated based on the smallest amount of charge among the amount of charges accumulated in each of the plurality of charge accumulation units CS provided in the pixel 321. For example, the distance image processing unit 4 calculates the number of pixels with high pixel values each time the driving for one frame is performed in the power saving mode M2.

Step S33: The distance image processing unit 4 stores the number of pixels with high pixel values in a storage unit (not shown).

Step S34: The distance image processing unit 4 determines whether or not the difference between the number of pixels with high pixel values in the current driving and the number of pixels with high pixel values in the previous driving is a second threshold value or greater. In a case where the difference is less than the second threshold value, the distance image processing unit 4 returns to the processing shown in step S30. In a case where the difference is the second threshold value or greater, the distance image processing unit 4 executes the processing shown in step S35.

Step S35: The distance image processing unit 4 determines that a moving object is present in the space to be measured, and shifts from the power saving mode M2 to the normal mode.

Next, another example of the flow of the processing of determining the presence or absence of a moving object will be described using FIG. 17.

Step S40: The distance image processing unit 4 drives the pixel 321 in the power saving mode M2.

Step S41: A first power saving map is generated in which the pixel values of the pixels 321 driven in the power saving mode M2 are mapped.

Step S42: The distance image processing unit 4 calculates the pixel value of a pixel by performing binning and regarding a plurality of pixels in the first power saving map as one pixel by combining the plurality of pixels, and generates an image in which the number of pixels is smaller than that in the first power saving map (hereinafter, referred to as a second power saving map). Any method in the related art can be adopted as a method of regarding a plurality of pixels as one pixel by combining the plurality of pixels, without being limited to the binning.

In addition, the distance image processing unit 4 may not perform the binning shown in step S42 and execute the processing shown in steps S43 and subsequent steps by using an image in which only the pixel values of pixels provided in specific regions of a part of the pixel 321 driven in the power saving mode M2 in step S41, for example, the upper or lower region shown in FIG. 13, or pixels provided in a central region divided into nine regions obtained by dividing each of vertical and horizontal directions of the first power saving map vertically and horizontally into three equal parts, are mapped as the second power saving map.

Step S43: The distance image processing unit 4 performs edge detection on the second power saving map, and generates a binarized image (hereinafter, referred to as a binarized map) according to whether or not the pixel is a pixel in which an edge is detected. As a method of performing the edge detection, for example, a method can be considered in which smoothing processing such as a median filter is performed on the image to remove a sharp change in pixel values due to noise, and then a location where pixel values change sharply is extracted using a differential filter. Here, when performing the edge detection, the smoothing processing of removing noise may be omitted.

In addition, the distance image processing unit 4 may combine the result of performing the edge detection and the calculation result of the distance to improve the accuracy of the edge detection. For example, a distance is calculated between each of the pixels in which the edge is detected and the pixels provided in the periphery thereof, and a difference is calculated between a distance value (first distance value) based on the pixel in which the edge is detected and a distance value (second distance value) based on the pixels provided in the periphery thereof. The distance image processing unit 4 determines that the edge is detected in a case where the difference is a predetermined value or greater and it is shown that the distance changes sharply, and determines that the distance has not changed sharply in a case where the difference is less than a predetermined value, and that the edge is not detected.

Step S44: The distance image processing unit 4 calculates an addition value obtained by adding each of the pixel values of the pixels arranged in the specific direction region along the specific direction in the binarized map. The specific direction is an arrangement direction of the pixels 321 arranged in a two-dimensional matrix, and may be any of a vertical direction, a horizontal direction, or a diagonal direction. The distance image processing unit 4 calculates an addition value for each of the plurality of specific directions, for example, each time driving is performed for one frame in the power saving mode M2.

FIGS. 18 and 19 show an example of the binarized map MAP (binarized maps MAP1 and MAP2) and an addition value calculated in each of the binarized maps MAP. In the example of the binarized map MAP in FIGS. 18 and 19, “1” is set in a pixel in which an edge is detected, and “0 (zero)” is set in a pixel in which an edge is not detected.

In an addition result Add1 in FIG. 18, an addition value obtained by adding each of the pixel values of the pixels arranged in the vertical direction among the pixels 321 arranged in the light receiving region 320 is shown for each column. In a case where the specific direction is the vertical direction in this manner, the specific direction region is each of the regions in columns C1 to C10 vertically long in a column along the vertical direction. For example, in the addition result Add1, it is shown that the addition value in the column C1 is “4”, the addition value in the column C2 is “2”, the addition value in the column C9 is “3”, and the addition value in the column C10 is “0 (zero)”.

In an addition result Add2 in FIG. 18, an addition value obtained by adding each of the pixel values of the pixels arranged in the horizontal direction among the pixels 321 arranged in the light receiving region 320 is shown. In a case where the specific direction is the horizontal direction in this manner, the specific direction region is each of the regions in rows L1 to L10 horizontally long in a column along the horizontal direction. For example, in the addition result Add2, it is shown that the addition value in the row L1 is “0 (zero)”, the addition value in the row L2 is “3”, the addition value in the row L9 is “5”, and the addition value in the row L10 is “0 (zero)”.

In an addition result Add3 in FIG. 19, an addition value obtained by adding each of the pixel values of the pixels arranged in the vertical direction among the pixels 321 arranged in the light receiving region 320 is shown for each column. For example, in the addition result Add3, it is shown that the addition value in the column C1 is “0 (zero)”, the addition value in the column C2 is “4”, the addition value in the column C9 is “5”, and the addition value in the column C10 is “0 (zero)”.

In an addition result Add4 in FIG. 19, an addition value obtained by adding each of the pixel values of the pixels arranged in the horizontal direction among the pixels 321 arranged in the light receiving region 320 is shown. For example, in the addition result Add4, it is shown that the addition value in the row L1 is “0 (zero)”, the addition value in the row L2 is “4”, the addition value in the row L9 is “4”, and the addition value in the row L10 is “1”.

Step S45: The distance image processing unit 4 stores the addition value in a storage unit (not shown) in association with the specific direction region. For example, in a case where the vertical direction is set as the specific direction in the binarized map MAP shown in FIG. 18, the distance image processing unit 4 causes the storage unit to store the addition value “4” in the column C1, which is a specific direction region along the vertical direction.

Step S46: The distance image processing unit 4 calculates the specific direction region (change region) in which the difference between the addition value in the current driving and the addition value in the previous driving is the third threshold value or greater. For example, in a case where the addition value in the column C1 calculated previously is 3 or less or 5 or more, and the difference between the addition value “4” in the column C1 calculated this time is the third threshold value or greater (for example, 1), the distance image processing unit 4 sets the column C1 as the change region. On the other hand, in the distance image processing unit 4, in a case where the addition value in the column C1 calculated previously is 4, and the difference between the addition value in the column C1 calculated this time is less than the third threshold value (for example, 1), the distance image processing unit 4 does not set the column C1 as the change region.

Step S47: The distance image processing unit 4 determines whether or not the addition value is calculated for all the specific direction regions in which the difference is required to be calculated, in a case where there is a specific direction for which an addition value is not calculated, executes the processing shown in step S44, and in a case where the addition values are calculated for all the specific directions for which the addition values are required to be calculated, executes the processing shown in step S48. For example, in a case where the vertical direction is set as the specific direction in the binarized map MAP shown in FIG. 18, and there is a column among columns C1 to C10 for which the addition value is not calculated yet, the distance image processing unit 4 returns to the processing shown in step S44, and in a case where the addition value for each of the columns C1 to C10 is calculated, executes the processing shown in step S48.

Step S48: The distance image processing unit 4 calculates the number of specific direction regions in which the difference is the third threshold value or greater (the number of change regions).

Step S49: The distance image processing unit 4 determines whether or not the number of change regions is the fourth threshold value or greater. In a case where the number of change regions is less than the fourth threshold value, the distance image processing unit 4 returns to the processing shown in step S40. In a case where the number of change regions is the fourth threshold value or greater, the distance image processing unit 4 executes the processing shown in step S50.

Step S50: The distance image processing unit 4 determines that a moving object is present in the space to be measured, and shifts from the power saving mode M2 to the normal mode.

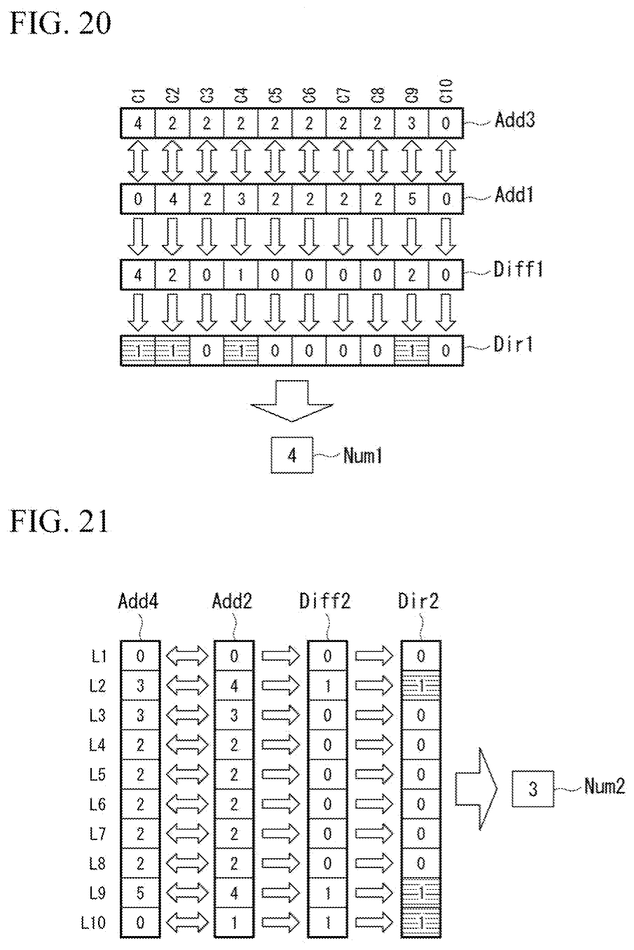

In FIGS. 20 and 21, examples of the addition result Add (addition results Add1 to Add4), the difference result Diff (difference results Diff1 and Diff2), the specific direction region Dir (specific direction regions Dir1, Dir2), and the number of change regions Num (the numbers of change regions Num1 and Num2) are shown. Here, the binarized map MAP1 shown in FIG. 18 is a binarized map corresponding to the previous driving, and the binarized map MAP2 shown in FIG. 19 is a binarized map corresponding to the current driving.

The difference result Diff1 in FIG. 20 shows the difference between the addition result Add1 and the addition result Add3 of each of FIGS. 18 and 19 in the specific direction region in which the vertical direction is the specific direction. For example, it is shown that a difference between the addition value “3” in column C1 shown in the addition result Add3 and the addition value “0 (zero)” in column C1 shown in the addition result Add1 is “4”. In addition, it is shown that the difference between the addition value “2” in column C3 shown in the addition result Add3 and the addition value “2” in column C3 shown in the addition result Add1 is “0 (zero)”.

In the specific direction region Dir1 in FIG. 20, a specific direction region in which the difference is the third threshold value (here, 1) or greater is shown by “1”, and a specific direction region in which the difference is less than the third threshold value (here, 1) is shown by “0 (zero)”. For example, in the specific direction region Dir1, it is shown that the difference “4” in the column C1 is a third threshold value or greater for the column C1. In addition, it is shown that the difference “0 (zero)” in the column C3 is less than the third threshold value for the column C3.

In the specific region number Num1 in FIG. 20, the number of specific direction regions in which the difference is the third threshold value (here, 1) or greater is shown. Here, in the specific direction region Dir1, since four columns of the column C1, the column C2, the column C4, and the column C9, are the third threshold value or greater, it is shown that specific region number Num1 is “4”.

In the difference result Diff2 in FIG. 21, the difference between the addition result Add2 and the addition result Add4 in each of FIGS. 18 and 19 in the specific direction region in which the horizontal direction is the specific direction is shown. For example, it is shown that a difference between the addition value “0 (zero)” in the row L1 shown in the addition result Add4 and the addition value “0 (zero)” in the row L1 shown in the addition result Add2 is “0 (zero)”. In addition, it is shown that a difference between the addition value “3” in the row L2 shown in the addition result Add4 and the addition value “4” in the row L2 shown in the addition result Add2 is “1”.

In the specific direction region Dir2 in FIG. 21, a specific direction region in which the difference is the third threshold value (here, 1) or greater is shown by“1”, and a specific direction region in which the difference is less than the third threshold value (here, 1) is shown by “0 (zero)”. For example, in the specific direction region Dir2, it is shown that the difference “0 (zero)” in the row L1 is less than the third threshold value for the row L1. In addition, it is shown that the difference “1” in the row L2 is the third threshold value or greater for the row L2.

In the specific region number Num2 in FIG. 21, the number of specific regions in which the difference is the third threshold value (here, 1) or greater is shown. Here, in the specific direction region Dir2, since three rows of the row L2, the row L9, and the row L10 are the third threshold value or greater, it is shown that the specific region number Num2 is “3”.

As described above, the distance image capturing device 1 according to the embodiment includes the light source unit 2, the light receiving unit 3, and the distance image processing unit 4. In a normal mode, the distance image processing unit 4 accumulates the charges in each of the charge accumulation units CS1 to CS4 at the accumulation timing synchronized with the emission timing of emitting the optical pulse PO, and calculates the distance to the subject OB that is present in the space to be measured based on the accumulated signal (the amount of charge accumulated in the each of the charge accumulation units CS). The distance image processing unit 4 executes either the normal mode or the power saving mode having lower power consumption than the normal mode. The distance image processing unit 4 accumulates the charges in the charge accumulation unit CS at least once in the power saving mode, and determines whether or not a moving object is present in the space in response to the amount of charge accumulated in the charge accumulation unit CS. In a case where the moving object is present, the distance image processing unit 4 determines that the return condition is satisfied, and releases the power saving mode. In addition, in the normal mode, the distance image processing unit 4 determines whether or not a moving object is present in the space, in response to the amount of charge accumulated in each of the charge accumulation units CS, and in a case where the distance image processing unit 4 is determined that a moving object is not present in the space, the mode is shifted to the power saving mode.

As a result, in the distance image capturing device 1 according to the embodiment, it is possible for the charge accumulation unit CS to accumulate charges at least once in the power saving mode, and to determine whether or not a moving object is present in the space in response to the accumulated signal. Therefore, even when the power saving mode is executed, it is possible to detect the entering of the moving object in a case where the moving object enters the space to be measured. Moreover, since the charge may be accumulated in the charge accumulation unit CS at least once in the power saving mode, the power consumption can be reduced compared to the normal mode. Therefore, it is possible to detect that the moving object enters the space to be measured and release the power saving mode while reducing power consumption. That is, it is possible to execute processing related to the sleep function suitable for the distance image capturing device.

In addition, in the distance image capturing device 1 according to the embodiment, the distance image processing unit 4 executes the power saving mode when the distance image capturing device 1 is activated. As a result, in the distance image capturing device 1 according to the embodiment, the power saving mode can be executed at the time of activation, and the power consumption can be suppressed as compared with the case where the normal mode is executed.

In addition, in the distance image capturing device 1 according to the embodiment, in the power saving mode M1, the distance image processing unit 4 stops emitting the optical pulse PO, and periodically causes the charge accumulation unit CS included in each of the pixels 321 to accumulate charges corresponding to background light (external light). The distance image processing unit 4 determines whether or not a moving object is present in the space to be measured, according to a change in the amount of charge accumulated in the charge accumulation unit CS. As a result, even in a case where the emission of the optical pulse PO is stopped, it is possible to determine whether or not a moving object is present in the space to be measured, and it is possible to detect that the moving object enters the space to be measured and release the power saving mode while reducing power consumption.

In addition, in the distance image capturing device 1 according to the embodiment, in the power saving mode M2, the frequency of emitting the optical pulse PO is reduced than that in the normal mode, and the charges are accumulated in each of the charge accumulation units CS at the accumulation timing. The distance image processing unit 4 determines whether or not a moving object is present in the space according to a change in the pixel 321 received the reflected light RL of the optical pulse PO. As a result, even in a case where the frequency of emitting the optical pulse PO is decreased, it is possible to determine whether or not a moving object is present in the space to be measured, and it is possible to detect that the moving object enters the space to be measured and release the power saving mode while reducing power consumption.

In addition, in the distance image capturing device 1 according to the embodiment, in the modification example of the power saving mode M2, the frequency of emitting the optical pulse PO is reduced than that in the normal mode, and the emission timing of emitting the optical pulse PO is delayed compared to the normal mode. The distance image processing unit 4 determines whether or not a moving object is present in the space according to a change in the amount of charge accumulated in the charge accumulation unit CS. As a result, in a case where the moving object is not present in the space, the charge corresponding to the reflected light RL reflected by a distant object (for example, a wall surrounding the space) is not accumulated in the charge accumulation unit CS. In a case where the moving object enters, charges corresponding to the reflected light RL reflected by a close moving object are accumulated in the charge accumulation unit CS. Therefore, it is possible to easily detect that the moving object enters the space according to whether or not the charge corresponding to the reflected light RL is accumulated in the charge accumulation unit CS.

In addition, in the distance image capturing device 1 according to the embodiment, the reflecting object OBH is installed in the space to be measured. In the power saving mode M2, the distance image processing unit 4 reduces the frequency of emitting the optical pulse PO than that in the normal mode. The distance image processing unit 4 determines whether or not a moving object is present in the space according to a change in the amount of light received in the pixel 321 that receives the light arriving from the reflecting object OBH. As a result, it is possible to accurately determine whether or not a moving object is present in the space to be measured by receiving light arriving from the reflecting object OBH, and it is possible to detect that the moving object enters the space to be measured and release the power saving mode while reducing power consumption.

In addition, in the distance image capturing device 1 according to the embodiment, the light-emitting object OBL is installed in the space to be measured. The distance image processing unit 4 stops emitting the optical pulse PO in the power saving mode M1. The distance image processing unit 4 determines whether or not a moving object is present in the space according to a change in a pixel that receives light arriving from the light-emitting object OBL. As a result, even in a case where the optical pulse PO is not emitted, it is possible to accurately determine whether or not a moving object is present in the space to be measured by receiving light arriving from the light-emitting object OBL, and it is possible to detect that the moving object enters the space to be measured and release the power saving mode while reducing power consumption.

In addition, in the distance image capturing device 1 according to the embodiment, the distance image processing unit 4 drives a smaller number of pixels in the power saving mode than in the normal mode. For example, the distance image processing unit 4 drives only a part of the pixels 321 among the pixels 321 arranged in the light receiving region 320 in the power saving mode. The distance image processing unit 4 determines whether or not a moving object is present in the space according to a change in the amount of charge accumulated in the charge accumulation unit CS in the pixel 321 that is driven. As a result, in the distance image capturing device 1 according to the embodiment, it is possible to suppress the power consumed in the power saving mode and to shorten the time required to detect the presence or absence of the moving object.

In addition, in the distance image capturing device 1 according to the embodiment, the distance image processing unit 4 drives the plurality of pixels 321, and calculates the number of pixels with high pixel values, which is the number of pixels whose pixel values are the first threshold value or greater among the driven pixels 321. The distance image processing unit 4 calculates a difference between the number of pixels with high pixel values by the current driving and the number of pixels with high pixel values by the previous driving. The distance image processing unit 4 determines that a moving object is present in the space in a case where the difference is the second threshold value or greater. As a result, in the distance image capturing device 1 of the embodiment, in a case where the number of pixels 321 whose pixel values change significantly (the first threshold value or greater) compared to the previous time is large (the second threshold value or greater), it can be determined that a moving object is present in the space. Therefore, it is possible to quantitatively determine the presence or absence of a moving object in the measurement space by simple processing of comparing with the threshold value.

In addition, in the distance image capturing device 1 according to the embodiment, as shown in FIG. 2, the plurality of pixels 321 are arranged in a two-dimensional matrix. The distance image processing unit 4 drives the plurality of pixels 321. The distance image processing unit 4 calculates an addition value obtained by adding each of the pixel values of the pixels 321 arranged along the specific direction among the driven pixels 321. In a case where the number of specific directions in which a difference between the addition value in the current driving and the addition value in the previous driving is a third threshold value or greater is a fourth threshold value or greater, the distance image processing unit 4 determines that a moving object is present in the space. As a result, in the distance image capturing device 1 according to the embodiment, it is possible to quantitatively determine the presence or absence of a moving object in the measurement space, based on the total amount of changes in the pixel values of each of the pixels included in the pixel column arranged in the specific direction such as the vertical direction, the horizontal direction, or the diagonal direction. In a case where the moving object moves in the measurement space, there is a high probability that the pixel value of the pixel column along the specific direction changes significantly. Therefore, it is possible to accurately determine the presence or absence of a moving object in the measurement space by simple processing of comparing with the threshold value.

In addition, in the distance image capturing device 1 according to the embodiment, the distance image processing unit 4 determines that a moving object is present in the space using the pixel value of a pixel obtained by regarding the plurality of pixels 321 as one pixel by combining the plurality of pixels 321 subjected to the driving like binning. Alternatively, the distance image processing unit 4 determines that a moving object is present in the space, by using pixel values of a part of the pixels 321 among the plurality of driven pixels 321. As a result, in the distance image capturing device 1 according to the embodiment, it is possible to determine whether or not a moving object is present in the space without using all of the driven pixels, and it is possible to reduce the processing load related to the determination.

In addition, in the distance image capturing device 1 according to the embodiment, the distance image processing unit 4 performs edge detection on an image (for example, a first power saving map, a second power saving map, and the like) including the pixels 321 driven in the power saving mode M2. The distance image processing unit 4 calculates the addition value using the image (binarized map MAP) binarized according to whether or not the pixel is a pixel in which the edge is detected. As a result, it is possible to determine whether or not a moving object is present in the space, based on a change in the number of pixels in which an edge is detected. In a case where the moving object moves in the measurement space, a contour of the moving object is detected as an edge, and there is a high probability that the position of the edge changes each time the pixel is driven. Therefore, it is possible to accurately determine whether or not a moving object is present in the measurement space.

In addition, in the distance image capturing device 1 according to the embodiment, the distance image processing unit 4 determines that a moving object is present in the space using a pixel value corresponding to the amount of charge accumulated in one specific charge accumulation unit CS provided in the pixel 321. Alternatively, the distance image processing unit 4 determines that a moving object is present in the space by using a pixel value corresponding to the amount of light of the reflected light RL of the optical pulse PO incident on the pixel 321. Alternatively, the distance image processing unit 4 may determine that a moving object is present in the space by using a pixel value corresponding to a distance value calculated for each pixel 321. The distance image processing unit 4 can calculate the distance value using the same method as the method of calculating the distance in the normal mode.

In addition, in the distance image capturing device 1 according to the embodiment, the distance image processing unit 4 releases the power saving mode in a case where the control signal for releasing the power saving mode is acquired from the external device in the power saving mode. As a result, in the distance image capturing device 1 according to the embodiment, even in a case where the device does not operate as a distance measuring device or an IR camera in the power saving mode and the moving object cannot be detected by signal processing using the accumulated signal, it is possible to release the power saving mode.

### Modification Example of Embodiment

Here, a modification example of the embodiment will be described. The present modification example differs from the above-described embodiment in that stepwise drive for shifting to the normal mode, specifically, pre-drive or high-speed drive, which will be described later, is executed after releasing the power saving mode and before executing the normal mode.

First, the pre-drive will be described. The pre-drive is a drive in which power consumption is reduced than the normal mode. Even in a case where the moving object is detected in the power saving mode, thereafter, there may be the case where the moving object (for example, a person) continuously passes through the space to be measured or the case where the moving object does not pass at all. In a case where the moving object does not pass at all, the normal mode is immediately released after shifting to the normal mode, and the mode returns to the power saving mode. Thus, switching between executing and releasing the normal mode is frequently performed, so that there is a possibility that the power consumption increases.

On the other hand, in the present modification example, even in a case where the moving object is detected while the power saving mode is executed, the pre-drive is executed without immediately shifting to the normal mode. While the pre-drive is executed, in a case where the moving object is detected within a predetermined time, the mode is shifted to the normal mode, and in a case where the moving object is not detected within the predetermined time, the mode is shifted to the power saving mode. As a result, the frequency of switching for executing or releasing the normal mode is suppressed such that power consumption is not increased.

The pre-drive may be any drive as long as the moving object can be detected at least during execution and has lower power consumption than that in the normal mode. For example, the pre-drive is the same drive as that in the power saving mode M1 or M2. Alternatively, in the pre-drive, the charges may be accumulated at a high frequency in the power saving mode M1 or M2.

In addition, the method for detecting a moving object while the pre-drive is executed is the same as the method for detecting the moving object in the power saving mode M1 or M2.

Next, the high-speed drive will be described. The high-speed drive is a drive that increases the number of frames executed per unit time compared to the normal mode. For example, in a case of 30 frames/sec in the normal mode, drive is performed at 60 frames/sec in the high-speed drive.

In a case where the moving object is detected in the power saving mode, even when the normal mode is executed thereafter, there is a possibility that the movement of the moving object cannot be detected depending on the speed at which the moving object moves. On the other hand, in the present modification example, in a case where the moving object is detected while the power saving mode is executed, the high-speed drive is executed. After the high-speed drive is executed for a predetermined time, the mode is shifted to the normal mode. As a result, it is possible to measure the movement of the moving object detected in the power saving mode.

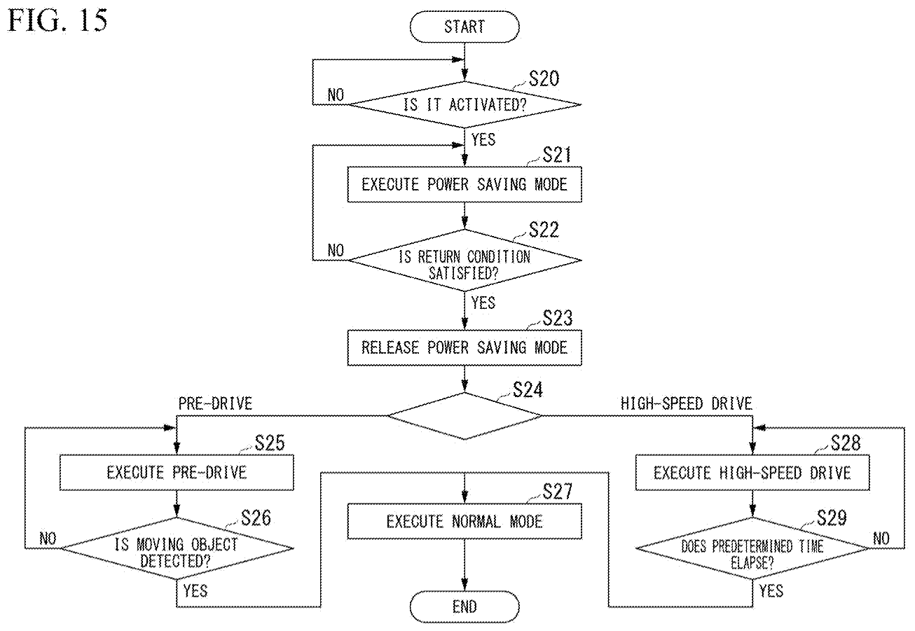

Here, a flow of processing performed by the distance image capturing device 1 will be described with reference to FIG. 15. FIG. 15 is a flowchart showing the flow of processing performed by the distance image processing unit 4 according to the embodiment. In FIG. 15, since the processing shown in steps S20 to S23 and S27 is the same as that in steps S10 to S13 and S14 in FIG. 4, a description thereof will be omitted.

In step S24, the distance image processing unit 4 determines whether to perform the pre-drive or the high-speed drive. Whether to perform the pre-drive or the high-speed drive may be randomly determined according to the measurement environment or the like.

In a case where the distance image processing unit 4 is determined that the pre-drive is to be performed in step S24, the distance image processing unit 4 executes the pre-drive (step S25), and determines whether or not a moving object is detected while the pre-drive is executed (step S26). In a case where the distance image processing unit 4 is determined that a moving object is detected, the distance image processing unit 4 proceeds to step S27 and executes the normal mode.

On the other hand, in a case where the distance image processing unit 4 is determined that the high-speed drive is to be executed in step S24, the distance image processing unit 4 executes the high-speed drive (step S28), and after a predetermined time elapses (step S29), the process proceeds to step S27, and executes the normal mode.

As described above, in the distance image capturing device 1 in the modification example of the embodiment, the distance image processing unit 4 performs the pre-operation drive after releasing the power saving mode. In the pre-operation drive, the distance image processing unit 4 accumulates the charges in each of the charge accumulation units at the accumulation timing. The distance image processing unit 4 shifts to the normal mode in a case where the moving object is detected in the space to be measured within a predetermined time in the pre-operation drive. On the other hand, the distance image processing unit 4 shifts to the power saving mode in a case where the moving object is not detected within a predetermined time in the pre-operation drive. As a result, even in a case where the moving object is detected in the power saving mode, thereafter, in a case where a state where the moving object is not detected continues, it is possible to continue the power saving mode without executing the normal mode. Therefore, it is possible to suppress frequently performed switching for executing or releasing the normal mode such that power consumption is not increased.

In addition, in the distance image capturing device 1 in the modification example of the embodiment, the distance image processing unit 4 performs the high-speed drive after releasing the power saving mode. In high-speed drive, the distance image processing unit 4 increases the frequency of emitting the optical pulse compared to the normal mode, accumulates the charges in each of the charge accumulation units CS at the accumulation timing, calculates the distance to the subject OB that is present in the space based on the amount of charge accumulated in each of the charge accumulation units CS, and shifts to the normal mode after executing the high-speed drive for a predetermined time. As a result, in a case where the moving object is detected in the power saving mode, even in a case where the moving object moves quickly, the movement of the moving object can be measured by executing the high-speed drive.

Here, in the case of shifting to the high-speed drive or the normal mode without performing the pre-operation drive when the moving object is detected, it is desirable that the distance image capturing device 1 executes the power saving mode that can shorten the time required to shift to the high-speed drive or the normal mode. For example, in the power saving mode, in a case where the charge is accumulated at the same accumulation timing as in the normal mode and only the light emission of the optical pulse PO is stopped, by restarting the emission of optical pulses while continuing the processing of accumulating charges, it is possible to immediately shift to the normal mode, and to shorten the period of shifting to the normal mode.

In addition, in a case where the number of pixels 321 to be driven in the power saving mode is smaller than that in the normal mode, the number of accumulated signals to be output can be reduced than that in the normal mode. Therefore, the time for determining the presence or absence of the moving object according to a change in the amount of charge or the like can be shortened, compared to a case where all the pixels 321 are driven to determine the presence or absence of the moving object. Therefore, it is possible to shorten the time from detection of the moving object to shift to the normal mode or the like, and to quickly shift from the power saving mode to the normal mode or the like to detect a moving object having a fast movement.

Although the embodiments of the invention have been described in detail with reference to the drawings, the specific configuration is not limited to these embodiments, and design and the like are included within the scope of the gist of the present invention.

For example, when the mode is shifted to the power saving mode by not detecting the moving object during execution of the normal mode, instead of immediately shifting to the power saving mode, the mode may be gradually shifted to the power saving mode while gradually reducing at least one of the frequency of emitting the optical pulse PO and the frequency of accumulating charges in the charge accumulation unit CS.

In addition, in the pre-drive, even in a case where the moving object is detected within a predetermined time, when the moving speed of the moving object is less than the threshold value, the object is present in the space to be measured, but the distance image processing unit 4 is determined that the object is not the moving object but a stationary object, the mode may return to the power saving mode without shifting to the normal mode. In this case, in the pre-drive, the distance image processing unit 4 controls so that the distance to the subject OB (moving object) is measured. The distance image processing unit 4 calculates the moving speed of the moving object based on the measured distance, and determines whether to shift to the normal mode or the power saving mode according to the calculated speed.

In addition, in a case where the light arriving from the light-emitting object OBL is received, the number of times of driving may be controlled such that the charges accumulated in the charge accumulation unit CS are saturated by receiving the light. The distance image processing unit 4 may determine whether or not the charges accumulated in the charge accumulation unit CS are saturated, every time the driving for one frame is performed, and determine that a moving object is detected in a case where the charge changes from a saturated state to an unsaturated state.

In addition, in FIGS. 8 and 9, the case where the operation is performed at a frequency of driving one frame per second is shown, but the present invention is not limited thereto. In the power saving mode M2, it may be driven so that the power consumption is reduced compared to the normal mode while emitting the optical pulse PO.

For example, in the power saving mode M2, the frequency may be further reduced than driving one frame per second. For example, in the power saving mode M2, it may be the frequency of driving one frame per five seconds. Also in the power saving mode M1, similarly, the IR image may be captured at a frequency of driving one frame per second, or the IR image may be captured at a frequency of driving one frame per five seconds.

In addition, in the power saving mode M2, the emission time of the optical pulse PO and the accumulation time in the charge accumulation unit CS may be set to be shorter than those in the normal mode.

In addition, in the power saving mode M2, one frame randomly selected each time from 30 frames which can be driven per second may be driven.

In addition, in the power saving mode M2, the number of times of emission of the optical pulse PO per frame and the number of times of accumulation in the charge accumulation unit CS may be smaller than those in the normal mode.

All or a part of the distance image capturing device 1 and the distance image processing unit 4 in the above-described embodiment may be implemented by a computer. In this case, a program for implementing the functions may be recorded on a non-transitory computer-readable recording medium, and a computer system may read and execute the program recorded on the recording medium to implement the functions. The “computer system” here includes an OS and hardware such as a peripheral device. In addition, the “computer-readable recording medium” refers to a portable medium such as a flexible disk, a magneto-optical disk, a ROM, or a CD-ROM, and a storage device such as a hard disk built in a computer system. Furthermore, a “computer-readable recording medium” may include a medium that dynamically holds the program for a short period of time, such as a communication line for transmitting the program via networks such as the Internet and communication lines such as telephone lines, and a medium that holds a program for a certain period of time, such as a volatile memory inside a computer system that is a server or a client in that case. In addition, the program may be configured to implement a part of the above-described function, may be configured to implement the above-described function by combination with the program recorded in advance in a computer system, or may be configured to implement the program by using a programmable logic device such as FPGA.

While preferred embodiments of the invention have been described and illustrated above, it should be understood that these are exemplary of the invention and are not to be considered as limiting. Additions, omissions, substitutions, and other modifications can be made without departing from the scope of the invention.

Accordingly, the invention is not to be considered as being limited by the foregoing description and is only limited by the scope of the appended claims.

### EXPLANATION OF REFERENCES

1: Distance image capturing device
2: Light source unit
3: Light receiving unit
321: Pixel
4: Distance image processing unit
CS: Charge accumulation unit
G1, G2, G3, G4: Charge transfer transistor
GD: Charge discharge transistor
PD: Photoelectric conversion element
PO: Optical pulse

What is claimed is:

1. A distance image capturing device comprising:
a light source unit configured to emit an optical pulse to a space which is a capturing target;
a light receiving unit configured to include a pixel having a photoelectric conversion element which generates a charge according to a light incident from the space and a plurality of charge accumulation units that accumulate the charge, and a pixel driving circuit which performs driving for accumulating the charge in each of the charge accumulation units to accumulate the charge; and
a distance image processing unit configured to control the pixel driving circuit, accumulate the charge in each of the charge accumulation units at an accumulation timing synchronized with an emission timing of emitting the optical pulse in a normal mode, and calculate a distance to a subject present in the space based on an amount of charge accumulated in each of the charge accumulation units, wherein
the distance image processing unit
executes either the normal mode or a power saving mode having lower power consumption than the normal mode,
in the power saving mode, accumulates the charge in the charge accumulation unit at a frequency which is the same as that in the normal mode or smaller than that in the normal mode, determines whether or not a moving object is present in the space according to the amount of charge accumulated in the charge accumulation unit, and releases the power saving mode as satisfying a return condition in a case where the moving object is present in the space, and
determines whether a moving object is present in the space according to the amount of charge accumulated in each of the charge accumulation units in the normal mode, and shifts to the power saving mode in a case where the distance image processing unit is determined that the moving object is not present in the space.

2. The distance image capturing device according to claim 1, wherein
the distance image processing unit executes the power saving mode when the distance image capturing device is activated.

3. The distance image capturing device according to claim 1, wherein
in the power saving mode, the distance image processing unit stops emitting the optical pulse, accumulates the charge in each of the charge accumulation units, and determines whether or not a moving object is present in the space according to a change in a pixel value corresponding to an amount of light received by a pixel receiving an external light.

4. The distance image capturing device according to claim 1, wherein
in the power saving mode, the distance image processing unit sets a frequency of emitting the optical pulse to be smaller than that in the normal mode, accumulates the charge in each of the charge accumulation units at the accumulation timing, and determines whether or not a moving object is present in the space according to a change in a pixel value corresponding to an amount of light received by a pixel receiving a reflected light of the optical pulse.

5. The distance image capturing device according to claim 1, wherein
in the power saving mode, the distance image processing unit sets a frequency of emitting the optical pulse to be smaller than that in the normal mode, accumulates the charge in each of the charge accumulation units at the accumulation timing, and determines whether or not a moving object is present in the space according to a change in the amount of charge accumulated in the charge accumulation unit.

6. The distance image capturing device according to claim 1, wherein
in the power saving mode, the distance image processing unit sets a frequency of emitting the optical pulse to be smaller than that in the normal mode, delays an emission timing of emitting the optical pulse compared to the normal mode, accumulates the charge in each of the charge accumulation units at the accumulation timing, and determines whether or not a moving object is present in the space according to a change in the amount of charge accumulated in the charge accumulation unit.

7. The distance image capturing device according to claim 1, wherein
in the power saving mode, the distance image processing unit performs the driving for a smaller number of pixels than that in the normal mode, and determines whether or not a moving object is present in the space according to a change in the amount of charge accumulated in the charge accumulation unit of the pixel subjected to the driving.

8. The distance image capturing device according to claim 7, wherein
the distance image processing unit performs the driving on a plurality of pixels, calculates the number of pixels with high pixel values, which is the number of pixels where a pixel value is a first threshold value or greater among the pixels subjected to the driving, and determines that the moving object is present in the space in a case where a difference between the number of pixels with high pixel values in current driving and the number of pixels with high pixel values in previous driving is a second threshold value or greater.

9. The distance image capturing device according to claim 7, wherein
a plurality of pixels are arranged in a two-dimensional matrix, and
the distance image processing unit performs the driving on the plurality of pixels, calculates an addition value obtained by adding each of pixel values of the pixels arranged along a specific direction among the pixels subjected to the driving, and determines that the moving object is present in the space in a case where the number of specific directions in which a difference between the addition value in the current driving and the addition value in the previous driving is a third threshold value or greater is a fourth threshold value or greater.

10. The distance image capturing device according to claim 9, wherein
the distance image processing unit determines that the moving object is present in the space using a pixel value of a pixel obtained by regarding the plurality of pixels as one pixel by combining the plurality of pixels subjected to the driving, or a pixel value of a part of pixels among the plurality of pixels subjected to the driving.

11. The distance image capturing device according to claim 9, wherein
the distance image processing unit performs edge detection on an image including the pixel subjected to the driving, and calculates the addition value using a binarized image according to whether or not the pixel is a pixel in which an edge is detected.

12. The distance image capturing device according to claim 8, wherein
the distance image processing unit determines that the moving object is present in the space using a pixel value corresponding to an amount of charge accumulated in one specific charge accumulation unit provided in the pixel, or a pixel value corresponding to an amount of light of a reflected light of the optical pulse incident on the pixel.

13. The distance image capturing device according to claim 1, wherein
a reflecting object is installed in the space, and
in the power saving mode, the distance image processing unit sets a frequency of emitting the optical pulses to be smaller than that in the normal mode, and determines whether or not a moving object is present in the space according to a change in a pixel value corresponding to an amount of light received by a pixel receiving a light arriving from the reflecting object.

14. The distance image capturing device according to claim 1, wherein
a light-emitting object is installed in the space, and
in the power saving mode, the distance image processing unit stops emitting the optical pulse, and determines whether or not a moving object is present in the space according to a change in a pixel value corresponding to an amount of light received by a pixel receiving a light arriving from the light-emitting object.

15. The distance image capturing device according to claim 1, wherein
the distance image processing unit performs a pre-operation drive after releasing the power saving mode, in the pre-operation drive, causes each of the charge accumulation units to accumulate the charge at the accumulation timing, determines whether or not a moving object is present in the space according to the amount of charge accumulated in each of the charge accumulation units, shifts to the normal mode in a case where the moving object is detected within a predetermined time in the pre-operation drive, and shifts to the power saving mode in a case where the moving object is not detected within a predetermined time in the pre-operation drive.

16. The distance image capturing device according to claim 1, wherein
the distance image processing unit performs a high-speed drive after releasing the power saving mode, in the high-speed drive, increases a frequency of emitting the optical pulse compared to the normal mode, causes each of the charge accumulation units to accumulate the charge at the accumulation timing, calculates the distance to the subject present in the space based on the amount of charge accumulated in each of the charge accumulation units, and shifts to the normal mode after performing the high-speed drive for a predetermined time.

17. The distance image capturing device according to claim 1, wherein
in the power saving mode, the distance image processing unit releases the power saving mode in a case where a control signal for releasing the power saving mode is acquired from an external device.

18. A distance image capturing method performed by a distance image capturing device including a light source unit configured to emit an optical pulse to a space which is a capturing target, a light receiving unit configured to include a pixel having a photoelectric conversion element which generates a charge according to a light incident from the space and a plurality of charge accumulation units that accumulate the charge, and a pixel driving circuit which performs driving for accumulating the charge in each of the charge accumulation units, and a distance image processing unit configured to control the pixel driving circuit, accumulates the charge in each of the charge accumulation units at an accumulation timing synchronized with an emission timing of emitting the optical pulse in a normal mode, and calculates a distance to a subject present in the space based on an amount of charge accumulated in each of the charge accumulation units, the method comprising:
via the distance image processing unit,
executing either the normal mode or a power saving mode having lower power consumption than the normal mode,
in the power saving mode, accumulating the charge in the charge accumulation unit at a frequency which is the same as that in the normal mode or smaller than that in the normal mode, determining whether or not a moving object is present in the space according to the amount of charge accumulated in the charge accumulation unit, and releasing the power saving mode as satisfying a return condition in a case where the moving object is present in the space, and
determining whether a moving object is present in the space according to the amount of charge accumulated in each of the charge accumulation units in the normal mode, and shifting to the power saving mode in a case where the distance image processing unit is determined that the moving object is not present in the space.

19. A non-transitory computer-readable storage medium storing a program for causing a computer of a distance image capturing device including a light source unit configured to emit an optical pulse to a space which is a capturing target, a light receiving unit configured to include a pixel having a photoelectric conversion element which generates a charge according to a light incident from the space and a plurality of charge accumulation units that accumulate the charge, and a pixel driving circuit which performs driving for accumulating the charge in each of the charge accumulation units, and a distance image processing unit configured to control the pixel driving circuit, accumulates the charge in each of the charge accumulation units at an accumulation timing synchronized with an emission timing of emitting the optical pulse in a normal mode, and calculates a distance to a subject present in the space based on an amount of charge accumulated in each of the charge accumulation units, to execute a process comprising:
executing either the normal mode or a power saving mode having lower power consumption than the normal mode,
in the power saving mode, accumulating the charge in the charge accumulation unit at a frequency which is the same as that in the normal mode or smaller than that in the normal mode, determining whether or not a moving object is present in the space according to the amount of charge accumulated in the charge accumulation unit, and releasing the power saving mode as satisfying a return condition in a case where the moving object is present in the space, and
determining whether a moving object is present in the space according to the amount of charge accumulated in each of the charge accumulation units in the normal mode, and shifting to the power saving mode in a case where the distance image processing unit is determined that the moving object is not present in the space.

20. The distance image capturing device according to claim 9, wherein
the distance image processing unit determines that the moving object is present in the space using a pixel value corresponding to an amount of charge accumulated in one specific charge accumulation unit provided in the pixel, or a pixel value corresponding to an amount of light of a reflected light of the optical pulse incident on the pixel.
